(19) United States
(12) Patent Application Publication
(10) Pub. No.: US 2025/0005583 A1
(43) Pub. Date: Jan. 2, 2025

(54) SYSTEMS AND METHODS FOR AUTOMATIC GRADUATION OF SECURED INSTRUMENTS

(71) Applicant: Synchrony Bank, Stamford, CT (US)

(72) Inventor: William Kievit, Stamford, CT (US)

(21) Appl. No.: 18/753,243

(22) Filed: Jun. 25, 2024

Related U.S. Application Data
(60) Provisional application No. 63/510,404, filed on Jun. 27, 2023.

(51) Int. Cl. G06Q 20/40

(52) U.S. Cl. CPC G06Q 20/405; G06Q 20/401

(57) ABSTRACT

Systems and methods are provided for automatically and dynamically adjusting security deposits and credit limits associated with security payment instruments as these secured payment instruments are used for different transactions. Transactions and credit performance data associated with a secured payment instrument are monitored to determine whether an adjustment to a security deposit and a credit limit associated with the secured payment instrument can be performed. If an adjustment is performed, an account associated with the secured payment instrument is updated according to the adjustment. As new transactions and credit evaluations associated with the secured payment instrument are processed in real-time, new adjustments can be made to the security deposit and credit limit.

### CROSS-REFERENCE TO RELATED APPLICATIONS

The present patent application claims the benefit of priority to U.S. Provisional Patent Application 63/510,404 filed Jun. 27, 2023, which is incorporated herein by reference in its entirety for all purposes.

### FIELD

The present disclosure relates generally to automatic and dynamic adjustment to security deposits and credit limits associated with security payment instruments as these secured payment instruments are used for different transactions.

### SUMMARY

Disclosed embodiments provide a framework for automatically and dynamically adjusting security deposits and credit limits associated with security payment instruments as these secured payment instruments are used for different transactions. According to some embodiments, a computer-implemented method is provided. The computer-implemented method comprises automatically monitoring transactions associated with a secured payment instrument. The secured payment instrument is secured by a security deposit. Further, the secured payment instrument is associated with a user. The computer-implemented method further comprises obtaining a credit evaluation corresponding to the user. The computer-implemented method comprises training a machine learning algorithm to identify an adjustment to the security deposit and a credit limit associated with the secured payment instrument. The machine learning algorithm is trained using the monitored transactions, the credit evaluation, historical data, and issued secured payment instruments. The computer-implemented method further comprises updating an account associated with the secured payment instrument. The account is updated according to the adjustment. The computer-implemented method further comprises obtaining in real-time new transactions associated with the secured payment instrument and new credit evaluations corresponding to the user. The computer-implemented method further comprises updating the machine learning algorithm as the new transactions and the new credit evaluations are received. When the machine learning algorithm is updated, new adjustments are identified.

In some embodiments, the adjustment includes automatically reducing the security deposit associated with the secured payment instrument.

In some embodiments, the adjustment includes increasing the credit limit associated with the secured payment instrument.

In some embodiments, the computer-implemented method further comprises determining that the security deposit is no longer remaining as a result of the adjustment. The computer-implemented method further comprises automatically graduating the secured payment instrument to an unsecured payment instrument.

In some embodiments, the computer-implemented method further comprises determining that a ratio between the credit limit and the security deposit is greater than a threshold amount as a result of the adjustment. The computer-implemented method further comprises automatically graduating the secured payment instrument to an unsecured payment instrument.

In some embodiments, the computer-implemented method further comprises determining a set of user metrics for determining adjustments to the security deposit and the credit limit. The set of user metrics are determined based on an initial credit evaluation corresponding to the user. The computer-implemented method further comprises updating the historical data according to changes in a performance associated with usage of the secured payment instrument over time. The changes are determined according to the set of user metrics.

In some embodiments, the computer-implemented method further comprises automatically disbursing the security deposit as a result of the adjustment.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a payment instrument service monitors in real-time performance data associated with a secured payment instrument to determine whether to dynamically adjust a credit limit and/or a security deposit associated with the secured payment instrument in accordance with at least one embodiment;

FIG. 2 shows an illustrative example of an environment in which a graduation system associated with a payment instrument service processes in real-time performance data associated with a secured payment instrument to determine whether to dynamically adjust a credit limit and/or a security deposit associated with the secured payment instrument in accordance with at least one embodiment;

FIG. 3 shows an illustrative example of an environment in which a graduation algorithm automatically and in real-time processes performance and historical data associated with a secured payment instrument to determine whether to dynamically adjust a credit limit and/or a security deposit associated with the secured payment instrument in accordance with at least one embodiment;

FIG. 4 shows an illustrative example of an environment in which a graduation algorithm dynamically and in real-time reduces a security deposit associated with a secured payment instrument based on rewards earned by an account holder in accordance with at least one embodiment;

FIG. 5 shows an illustrative example of an environment in which a graduation algorithm dynamically and in real-time increases a credit limit associated with a secured payment instrument based on an improvement in account holder performance over time in accordance with at least one embodiment;

FIG. 6 shows an illustrative example of a process for issuing a secured payment instrument based on a received application and a corresponding credit evaluation in accordance with at least one embodiment;

FIG. 7 shows an illustrative example of a process for dynamically and in real-time reducing a security deposit associated with a secured payment instrument based on changes in performance related to real-time usage of the secured payment instrument in accordance with at least one embodiment;

FIG. 8 shows an illustrative example of a process for dynamically and in real-time adjusting a credit limit associated with a secured payment instrument based on changes in performance related to real-time usage of the secured payment instrument in accordance with at least one embodiment; and

FIG. 9 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework for automatically and dynamically adjusting security deposits and credit limits associated with security payment instruments as these secured payment instruments are used for different transactions. For instance, in real-time, the systems and methods described herein may evaluate performance and historical data associated with a secured payment instrument to determine whether an adjustment to the security deposit and/or the credit limit associated with the secured payment instrument may be made. For example, if the systems and methods described herein determine that the security deposit associated with a secured payment instrument may be reduced, the systems and methods described herein may reduce the security deposit amount in real-time and determine whether there is any security deposit remaining. If there is no security deposit remaining as a result of the adjustment, the systems and methods described herein may automatically graduate the secured payment instrument to an unsecured payment instrument. As another example, if the systems and methods described herein determine that the credit limit associated with the secured payment instrument may be increased, the systems and methods described herein may adjust the credit limit accordingly and determine whether a credit limit-to-security deposit ratio exceeds a pre-defined graduation threshold. If so, the systems and methods described herein may automatically graduate the secured payment instrument to an unsecured payment instrument and disburse the security deposit associated with the payment instrument to the account holder. Thus, the framework may provide for a dynamic and real-time adjustment of secured payment instruments that may lead to an automatic graduation of the secured payment instruments to unsecured payment instruments.

A secured payment instrument, as described in greater detail herein, may be a payment instrument associated with an account that is secured via a security deposit provided by an account holder and held in escrow by the payment instrument service. An unsecured payment instrument may be a payment instrument associated with an account that is not secured by a security deposit. Graduation of a secured payment instrument to an unsecured payment instrument may include converting the secured payment instrument to an unsecured payment instrument by, for example, returning the security deposit for the payment instrument, adjusting the credit limit of the payment instrument, updating various credit reporting agencies of the graduation, and other such operations. Graduation of a secured payment instrument to an unsecured payment instrument may also be referred to herein as a promotion of a secured payment instrument to an unsecured payment instrument.

As used herein and unless otherwise made expressly clear, “promotion” of a secured payment instrument to an unsecured payment instrument refers to the systems and methods described herein for graduating a secured payment instrument to an unsecured payment instrument rather than the conventional meaning of “promotion” (e.g., offering an incentive to promote participation or engagement with services associated with the payment instrument).

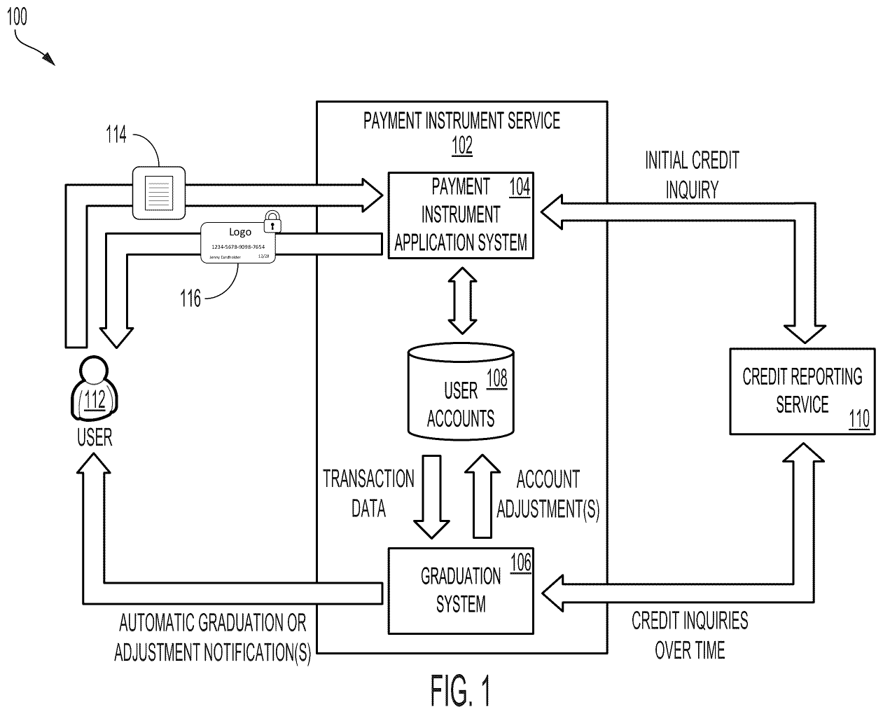

FIG. 1 shows an illustrative example of an environment 100 in which a payment instrument service 102 monitors in real-time performance data associated with a secured payment instrument 116 to determine whether to dynamically adjust a credit limit and/or a security deposit associated with the secured payment instrument 116 in accordance with at least one embodiment. In the environment 100, a user 112, through use of a computing device (e.g., smartphone, tablet computer, desktop computer, etc.), may submit an application 114 or other request to a payment instrument application system 104 of a payment instrument service 102 to obtain a line of credit associated with a secured payment instrument 116. In an embodiment, the application 114 or other request submitted by the user 112 includes information that may be used to perform a credit inquiry of the user's credit report to determine whether the user 112 is qualified for a line of credit associated with a secured payment instrument 116. For instance, through the application 114 or other request, the user 112 may provide their legal name, birthdate, last four digits of their Social Security number, household income, and the like.

In some instances, the user 112 may be associated with an existing account associated with the payment instrument service 102 (e.g., a third-party payment instrument service, a merchant, etc.). For instance, the user 112 may have an existing account associated with the payment instrument service 102 whereby the user 112 may have one or more existing lines of credit associated with secured and/or unsecured payment instruments. If the user 112 is associated with an existing account associated with the payment instrument service 102, the payment instrument application system 104 may query a user accounts datastore 108 maintained by the payment instrument service 102 to obtain any required information from the user's account that may be used to supplement the application 114 or other request to obtain a new line of credit associated with a secured payment instrument 116. For instance, if the user 112 has previously established other lines of credit associated with secured and/or unsecured payment instruments provided by the payment instrument service 102, the payment instrument application system 104 may obtain, from the user accounts datastore 108, any user information associated with these other lines of credit that may be used to perform the credit inquiry of the user's credit report.

In some instances, the user 112 may not have a pre-existing relationship with the payment instrument service 102. For instance, the user 112 may be a new customer that is interested in establishing a new line of credit through the payment instrument service 102. As an illustrative example, the user 112 may be presented with advertisements related to the payment instrument service 102, whereby the user 112 may be presented with different payment instrument options, including an option for a secured payment instrument 116, that may generally be available from the payment instrument service 102. These advertisements may be presented in the form of billboards, radio media, television or digital video media, banner advertisements, pop-up advertisements, and the like. In response to these advertisements, the user 112 may access the payment instrument service 102 to submit an application 114 or other request to determine whether the user 112 is eligible for the secured payment instrument 116 offered by the payment instrument service 102.

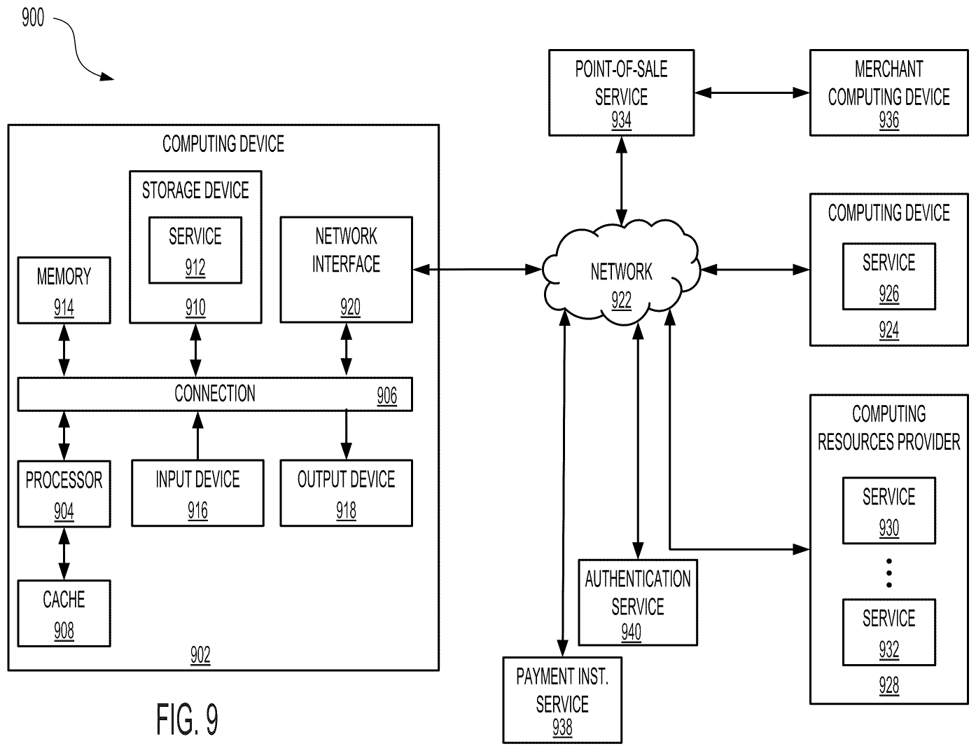

The payment instrument service 102, in an embodiment, is a service that, for example, processes applications for secured payment instruments, issues secured payment instruments, determines user-specific metrics for determining whether to adjust security deposits and/or credit limits associated with secured payment instruments, processes transactions associated with secured payment instruments, determines whether a secured payment instrument should be graduated to an unsecured payment instrument, processes the graduation of the secured payment instrument to an unsecured payment instrument, issues unsecured payment instruments, processes transactions associated with unsecured payment instruments, processes cancellations of accounts associated with secured and unsecured payment instruments, and performs other such operations. In an embodiment, the dual-feature payment instrument service 102 is a service such as the service 912 described herein at least in connection with FIG. 9. In an embodiment, the payment instrument service 102 is a service provided by a merchant such as the merchants described herein at least in connection with FIG. 9. In an embodiment, the payment instrument service 102 is a service provided by a computing resources provider such as the computing resource provide 928 described herein at least in connection with FIG. 9 (e.g., a service such as service 930 and/or service 932 described herein at least in connection with FIG. 9). In an embodiment, the dual-feature payment instrument service 102 is a payment instrument service such as the payment instrument service 938 described herein at least in connection with FIG. 9. In some instances, the payment instrument service 102 may be a service operated by the issuer of the secured payment instrument and/or the unsecured payment instrument. In some instances, the payment instrument service 102 may be a service operated by a third-party on behalf of the issuer of the secured payment instrument and/or the unsecured payment instrument.

The payment instrument application system 104 may be implemented using a computer system of the payment instrument service 102. In some instances, the payment instrument application system 104 may be implemented as an application or executable process that is executed on a computer system of the payment instrument service 102. In an embodiment, if the user 112 has provided a set of credentials corresponding to an existing account associated with the payment instrument service 102, the payment instrument application system 104 may authenticate the provided set of credentials to ensure that the set of credentials correspond to the existing account and that the user 112 is authorized to access this existing account. If the set of credentials are successfully authenticated, the payment instrument application system 104 may access the user accounts datastore 108 to retrieve any information required for a credit inquiry of the user's credit report from the user's existing account. If the user 112 does not have an existing account associated with the payment instrument service 102, the payment instrument application system 104 may forego this process of accessing the user accounts datastore 108 to retrieve the required information from an existing account.

In an embodiment, the payment instrument application system 104 automatically submits a credit inquiry to a credit reporting service 110 to obtain a credit evaluation for the user 112. For instance, the result of the credit inquiry may include one or more credit scores associated with the user 112, the current amount of credit allocated to the user 112 from different financial entities (including the payment instrument service 102, if any), the current amount of credit available to the user 112, and the like. The credit reporting service 110 may be associated with one or more credit agencies (e.g., Equifax®, TransUnion®, Experian®, etc.) or may otherwise interact with one or more credit agencies to provide credit reporting to users and other entities (such as the payment instrument application system 104). The payment instrument application system 104 may use the credit evaluation from the credit reporting service 110 to determine whether the user 112 can be approved for a secured payment instrument that the user 112 has applied for. If the payment instrument application system 104 determines that the user 112 cannot be approved for the applied for secured payment instrument, the payment instrument application system 104 may transmit a notification to the user 112 to indicate that the user 112 was not approved for the secured payment instrument.

If the payment instrument application system 104 determines, based on the credit evaluation for the user 112, that the user 112 is approved for a secured payment instrument, the payment instrument application system 104 may transmit a notification to the user 112 that they have been approved for a new line of credit associated with a secured payment instrument. Additionally, the payment instrument application system 104 may provide any related terms and conditions related to the secured payment instrument that the user 112 has been approved for (e.g., actual annual percentage rate (APR), amount of a line of credit associated with the secured payment instrument, the security deposit required for the secured payment instrument, etc.).

In an embodiment, if the user 112 is approved for a new line of credit associated with a secured payment instrument, the payment instrument application system 104 identifies a set of user metrics that may be used to determine whether adjustments to the credit limit and/or security deposit associated with the secured payment instrument may be performed. These particular user metrics may correspond to real-time usage of the secured payment instrument over time. For example, a user metric may correspond to the user's ability to providing on-time payments for existing balances associated with the secured payment instrument over time. As another illustrative example, another user metric may correspond to the user 112 staying within a particular budget (e.g., maintaining a balance associated with the secured payment instrument below a particular threshold value, etc.) over a pre-defined period of time. User metrics may further be tied to rewards offered by the payment instrument service 102 for using the secured payment instrument for different transactions (e.g., qualified purchases, promotional offers, etc.). In some instances, user metrics may also be tied to implementing one or more features associated with the secured payment instrument that may be used to better manage repayment of existing balances associated with the secured payment instrument (e.g., automatic payments, etc.).

In an embodiment, the payment instrument application system 104 implements and dynamically trains a machine learning algorithm or artificial intelligence to automatically determine the user metrics that can be used to dynamically determine whether to adjust a credit limit and/or security deposit associated with a secured payment instrument. The machine learning algorithm or artificial intelligence may be dynamically trained in real-time using unsupervised learning techniques. For instance, a dataset of account characteristics (e.g., historical data, hypothetical data, combinations of historical and hypothetical data, etc.) corresponding to sample users (e.g., actual users, hypothetical users, combinations of actual and hypothetical users, etc.) may be analyzed using a clustering or classification algorithm to classify the account data according to one or more vectors of similarity between the account data and clusters of similar account holders and corresponding payment instruments. The dataset of account characteristics, in some instances, may include data corresponding to user metrics assigned to secured payment instruments issued to the sample users, any adjustments made to credit limits and/or security deposits based on transaction data associated with these secured payment instruments and the assigned user metrics, and the like. The one or more vectors of similarity may correspond to credit scores, changes in credit scores, spending habits, total amount of credit allocated, total amount of credit available, payment performance, demographic information, payment instruments issued, payment instruments in default, and the like. Further, these similar account holders may correspond to the different payment instruments issued to these account holders and to corresponding user metrics based on the one or more vectors, as well as to the performance of these account holders in maintaining their accounts. Thus, in some embodiments, the payment instrument application system 104, through the machine learning algorithm or artificial intelligence, can perform such clustering and obtain partial matches among other clusters of account holders and corresponding payment instruments according to these one or more vectors of similarity to identify a particular cluster and, from this cluster, determine the user metrics that can be used to dynamically determine whether to adjust a credit limit and/or security deposit associated with a secured payment instrument.

In an embodiment, to dynamically train the machine learning algorithm or artificial intelligence used to determine the user metrics that can be used to dynamically determine whether to adjust a credit limit and/or security deposit associated with a secured payment instrument, the payment instrument application system 104 generates an initial iteration of the machine learning algorithm or artificial intelligence. For instance, the payment instrument application system 104 may initialize a set of coefficients {α1, α2, α3, . . . αn} randomly according to a Gaussian distribution with low variance centered around zero. Using this initial iteration of the machine learning algorithm or artificial intelligence, the payment instrument application system 104 may process the dataset of sample account characteristics corresponding to different sample users and secured payment instruments to generate an output. This output may specify, for each sample set of data corresponding to a sample user included in the dataset, an indication of different user metrics that may be associated with a new secured payment instrument and used to determine whether adjustments may be made to a credit limit and/or security deposit associated with the secured payment instrument. The payment instrument application system 104 may compare the output generated using the initial iteration of the machine learning algorithm or artificial intelligence to the sample user metrics defined in the dataset for each of the data points (e.g., secured payment instruments, users, etc.) to identify any inaccuracies or other errors.

If the output of the machine learning algorithm or artificial intelligence does not satisfy one or more criteria, the payment instrument application system 104 may iteratively update one or more coefficients of the set of coefficients to generate an updated machine learning algorithm or artificial intelligence. For instance, the one or more criteria may include a threshold for the accuracy of the desired machine learning algorithm or artificial intelligence for determining different user metrics that can be used to dynamically determine whether to adjust a credit limit and/or security deposit associated with a secured payment instrument based on account characteristics. The updated machine learning algorithm or artificial intelligence may be used to process the aforementioned training dataset, as well as any additional data points or other datasets provided by the payment instrument service 102 to generate a new output for each data point in the training dataset. In some instances, the payment instrument application system 104 may use an optimization algorithm to iteratively update the one or more coefficients of the set of coefficients associated with the machine learning algorithm or artificial intelligence. For instance, the payment instrument application system 104 may use gradient descent to update the logistic coefficients of the machine learning algorithm or artificial intelligence to generate new cutoff values that may be used to classify the data points of the previously evaluated dataset and of any new data points obtained by the payment instrument application system 104. The payment instrument application system 104 may use this updated machine learning algorithm or artificial intelligence to process the available data points and generate a new output. The payment instrument application system 104 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria.

In an embodiment, if the output generated by the machine learning algorithm or artificial intelligence satisfies the one or more criteria, the payment instrument application system 104 implements the machine learning algorithm or artificial intelligence to dynamically, and in real-time, process any account characteristics corresponding to new secured payment instruments to assign a set of user metrics that can be used to dynamically determine whether to adjust the credit limits and/or security deposits associated with these new secured payment instruments. In an embodiment, the payment instrument application system 104 uses new account characteristics (e.g., updates to user credit performance according to dynamic changes in the credit limit and/or security deposit amounts for existing secured payment instruments) as these new account characteristics are obtained to further retrain or otherwise update the machine learning algorithm or artificial intelligence. For instance, as the machine learning algorithm or artificial intelligence produces, in real-time or near real-time, outputs corresponding to different user metrics for different secured payment instruments, the payment instrument application system 104 or other evaluator of the machine learning algorithm or artificial intelligence may evaluate the output to determine whether the machine learning algorithm or artificial intelligence is generating appropriate user metrics and dynamically updating the credit limits and/or security deposits for corresponding secured payment instruments based on account holder performance along these user metrics. This evaluation may result in additional annotated data points that may be used to retrain or otherwise update the machine learning algorithm or artificial intelligence in real-time or near real-time. For instance, if the machine learning algorithm or artificial intelligence assigns a particular set of user metrics that results in an offer for graduation of the secured payment instrument 116 to an unsecured payment instrument and the user's credit performance subsequently declines (e.g., the user 112 has been delinquent in making payments towards balances associated with the unsecured payment instrument, the user 112 has not stayed on budget over a period of time, the user 112 has defaulted on various accounts, etc.), the corresponding data associated with the user 112 may be annotated to indicate that the machine learning algorithm or artificial intelligence has erroneously assigned a set of user metrics that were too lax. Additionally, in some instances, the corresponding data may be annotated with the appropriate or expected set of user metrics that should have been assigned to the secured payment instrument. These annotated data points may be added to the training dataset, which may be used to dynamically retrain or otherwise update the machine learning algorithm or artificial intelligence using the process described above.

In an embodiment, clustering algorithms are trained using sample datasets of account characteristics to classify secured payment instruments in order to determine the set of user metrics that may be used to determine whether to dynamically adjust the credit limits and/or security deposits associated with the secured payment instruments. Examples of such clustering algorithms may include, but are not limited to, k-means clustering algorithms, fuzzy c-means (FCM) algorithms, expectation-maximization (EM) algorithms, hierarchical clustering algorithms, density-based spatial clustering of applications with noise (DBSCAN) algorithms, and the like.

It should be noted that the payment instrument application system 104, through the machine learning algorithm or artificial intelligence, can continuously and simultaneously process account characteristics corresponding to different secured payment instruments and different users as these different secured payment instruments are issued to these different users. For instance, as the payment instrument application system 104 approves different applications for new lines of credit corresponding to different users, the payment instrument application system 104 may continuously and simultaneously process the account characteristics associated with these new lines of credit through the machine learning algorithm or artificial intelligence to define different sets of user metrics for dynamically updating the credit limits and/or security deposits associated with these new lines of credit over time. In some instances, the payment instrument application system 104 may be configured with various special-purpose components that can facilitate real-time or near real-time processing of different account characteristics corresponding to different secured payment instruments as these different secured payment instruments are approved and issued to any number of different users. Further, these various special-purpose components may be configured to automatically and in real-time or near real-time generate a user metrics for new secured payment instruments through the aforementioned machine learning algorithm or artificial intelligence.

Once the payment instrument application system 104 has determined the user metrics that may be used to automatically determine whether the credit limit and/or security deposit may be adjusted based on secured payment instrument transactions as they occur, the payment instrument application system 104 may provide the user 112 with information corresponding to the amount of the line of credit and of the security deposit required for the secured payment instrument 116. For instance, if the user 112 submitted their application for a new secured payment instrument 118 through an application or web portal provided by the payment instrument service 102, the payment instrument application system 104 may update a user interface (such as a graphical user interface (GUI)) associated with the application or web portal to present the amount of the line of credit, the required security deposit, and any other information associated with the secured payment instrument 116 (e.g., terms and conditions, interest rates, re-payment schedules, user metrics for dynamic adjustment of the credit limit and/or security deposit, etc.). If the user 112 agrees to the terms and conditions associated with the secured payment instrument 116, the payment instrument application system 104 may issue the secured payment instrument 116 to the user 112.

In an embodiment, the payment instrument service 102 includes a graduation system 106 that is implemented to monitor, in real-time, transactions associated with the secured payment instrument 116 as these transactions occur to dynamically determine whether to adjust the credit limit and/or security deposit associated with the secured payment instrument 116. The graduation system 106 may be implemented using a computer system of the payment instrument service 102. In some instances, the graduation system 106 may be implemented as an application or executable process that is executed on a computer system of the payment instrument service 102. In an embodiment, the graduation system 106 obtains transaction data in real-time that includes information regarding transactions involving the secured payment instrument 116 as these transactions occur. For instance, when a user 112 utilizes their secured payment instrument 116 to make a purchase at a point-of-sale, information corresponding to this purchase (e.g., purchase amount, identity of the merchant or other entity from which the purchase was made, etc.) may be obtained, in real-time, by the graduation system 106. In some instances, transactions involving the secured payment instrument 116 may be automatically added to the user accounts datastore 108, from which the graduation system 106 may obtain, in real-time, the transaction data associated with the secured payment instrument 116.

In addition to obtaining real-time transaction data as transactions involving the secured payment instrument 116 occur, the graduation system 106 may further obtain updated credit evaluations associated with the user 112 over time from the credit reporting service 110. As noted above, a credit evaluation may include one or more credit scores associated with the user 112, the current amount of credit allocated to the user 112 from different financial entities, the current amount of credit available to the user 112, and the like. The updated credit evaluations associated with the user 112 may be used by the graduation system 106 to identify any changes in the user's credit performance over time. For example, if the user 112 regularly provided on-time payments to the payment instrument service 102 to pay down any existing balances associated with the secured payment instrument 116 and any other payment instruments issued by the payment instrument service 102 to the user 112, the credit evaluation may indicate an improvement in the user's credit performance (e.g., improved credit scores, etc.). Similarly, if the user 112 maintains a budget whereby the user 112 does not utilize the maximum amount of available credit allocated to the user 112, the credit evaluation may further indicate an improvement in the user's credit performance.

To identify any substantive changes to the user's credit performance, the graduation system 106 may obtain historical data associated with the user 112 and the secured payment instrument 116 from the user accounts datastore 108. The historical data may include previously obtained credit evaluations associated with the user 112, trends corresponding to usage of the secured payment instrument 116 over time (e.g., frequency of use, balances over time, etc.), and any user metrics that may be used to determine whether to adjust the credit limit and/or security deposit associated with the secured payment instrument 116. Based on the newly obtained credit evaluation and the historical data, the graduation system 106 may dynamically identify any changes in the user's credit performance over time. Further, based on the obtained real-time transaction data and the historical data, the graduation system 106 may dynamically identify any changes to the trends corresponding to usage of the secured payment instrument 116.

In an embodiment, the graduation system 106 implements a machine learning algorithm or artificial intelligence that is dynamically trained to determine whether to adjust the credit limit and/or security deposit associated with the secured payment instrument 116. For instance, the graduation system 106 may track, in real-time, transaction data, historical data, credit evaluations from the credit reporting service 110, and assigned user metrics associated with the secured payment instrument 116 and other issued secured payment instruments in order to update a dataset used to train the machine learning algorithm or artificial intelligence implemented by the graduation system 106. This dataset may be updated based on the ongoing and real-time performance of users with regard to their secured payment instruments and the changes to credit limits and/or security deposits based on the performance of these users and according to the user metrics associated with these users. For example, as users utilize their secured payment instruments for different transactions, make payments towards existing balances associated with these secured payment instruments, as changes are otherwise made to these users' credit histories, and/or adjustments are made to the credit limit and/or security deposit associated with these secured payment instruments, the dataset may be updated in real-time accordingly. These dynamic, and real-time updates to the dataset used to train the machine learning algorithm or artificial intelligence implemented by the graduation system 106 may allow for the continuous and dynamic updating of this machine learning algorithm or artificial intelligence in real-time, thereby improving the accuracy of the machine learning algorithm or artificial intelligence in adjusting the credit limit and/or security deposit associated with a secured payment instrument 116.

As an illustrative example, if the machine learning algorithm or artificial intelligence determines that the user 112 has earned a cash back reward as a result of making on-time payments over a period of time, using their secured payment instrument 116 for qualified transactions, staying within a pre-defined budget (as determined based on credit evaluations over time), and has established automatic payments for paying down existing balances associated with the secured payment instrument 116, the machine learning algorithm or artificial intelligence may automatically apply this cash back reward to reduce the security deposit associated with the secured payment instrument 116. For instance, if the secured payment instrument 116 is securitized using a $250 security deposit, and the machine learning algorithm or artificial intelligence determines that the user 112 has earned a $15 cash back reward based on the aforementioned factors, the machine learning algorithm or artificial intelligence may automatically reduce the security deposit from $250 to $235. Further, the amount removed from the security deposit may be disbursed according to any user preferences (e.g., deposit into a bank account or other financial account, applied to any existing balances associated with the secured payment instrument 116, donate to a charity of choice, etc.).

As another illustrative example, if the machine learning algorithm or artificial intelligence determines that the credit limit associated with the secured payment instrument 116 may be increased as a result of making on-time payments over a period of time, demonstrable improvements in credit performance over a period of time, staying within a pre-defined budget, and the like, the machine learning algorithm or artificial intelligence may automatically update the user accounts datastore 108 to reflect this change to the credit limit associated with the secured payment instrument 116. For instance, if the machine learning algorithm or artificial intelligence increases the credit limit associated with a secured payment instrument 116 from $250 to $500 based on the aforementioned factors, the machine learning algorithm or artificial intelligence may automatically update the user accounts datastore 108 to indicate this change to the credit limit associated with the secured payment instrument 116. Further, the machine learning algorithm or artificial intelligence may cause the graduation system 106 to transmit a notification to the user 112 indicating this change to the credit limit associated with the secured payment instrument 116. This increase to the credit limit associated with the secured payment instrument 116 may be performed according to the user metrics associated with the user 112 and may be performed without requiring an additional security deposit. Thus, as the user's credit performance improves over time, the credit limit associated with the secured payment instrument 116 may continue to increase while the security deposit remains static.

It should be noted that, in some instances, the graduation system 106 may dynamically adjust both the credit limit and the security deposit associated with the secured payment instrument 116 based on the aforementioned factors and the user metrics assigned to the user 112. For instance, based on the user metrics defined for the user 112 and the secured payment instrument 116, the payment instrument service 102 may define a set of parameters for dynamically adjusting the credit limit and the security deposit associated with the secured payment instrument 116. For example, if the user's credit performance has improved by a threshold amount (e.g., credit scores have improved by a minimum number of points over a period of time, the user 112 has maintained a budget over a threshold amount of time, etc.), the payment instrument service 102 may define a parameter whereby the security deposit associated with the secured payment instrument 116 may be reduced and the credit limit associated with the secured payment instrument 116 may be increased.

In some instances, the payment instrument service 102 may define, for the user 112, different performance thresholds, whereby meeting or exceeding a particular performance threshold may result in different adjustments to the secured payment instrument 116. For example, if the user's credit performance according to the aforementioned user metrics exceeds a first threshold, the graduation system 106 may dynamically adjust the security deposit associated with the secured payment instrument 116. If the user's credit performance exceeds a second threshold (where the second threshold represents a greater performance compared to the first threshold), the graduation system 106 may subsequently increase the credit limit associated with the secured payment instrument 116 while preserving the previous security deposit amount. Further, if the user's credit performance exceeds a third threshold (where the third threshold represents an even greater performance compared to the first two thresholds), the graduation system 106 may both reduce the security deposit associated with the secured payment instrument 116 and increase the credit limit associated with the secured payment instrument 116. Thus, the payment instrument service 102 may configure different performance thresholds for users according to the user metrics and parameters associated to their secured payment instruments.

In an embodiment, the graduation system 106 can determine whether the secured payment instrument 116 can be graduated to an unsecured payment instrument upon reducing a security deposit associated with the secured payment instrument 116 and/or increasing the credit limit associated with the secured payment instrument 116. For example, if the graduation system 106 determines that the reduction in the security deposit associated with the secured payment instrument 116 results in the secured payment instrument 116 no longer being securitized by a security deposit (e.g., the security deposit has been reduced to zero), the graduation system 106 may determine that the secured payment instrument 116 may be graduated to an unsecured payment instrument. As another example, the graduation system 106 may determine that the secured payment instrument 116 may be graduated to an unsecured payment instrument if the ratio of the current credit limit associated with the secured payment instrument 116 to the amount of the security deposit associated with the secured payment instrument 116 exceeds a threshold value. For instance, if the ratio of the credit limit to the amount of the security deposit associated with the secured payment instrument 116 is greater than three (e.g., the credit limit is more than three times greater than the security deposit), the graduation system 106 may determine that the secured payment instrument 116 may be graduated to an unsecured payment instrument. The threshold value for the ratio may be pre-defined by the payment instrument service 102 and uniform amongst all users. Alternatively, the threshold value may be defined per user 112 based on various criteria (e.g., credit scores, changes in credit scores, spending habits, total amount of credit allocated, total amount of credit available, payment performance, demographic information, payment instruments issued, payment instruments in default, etc.). The various criteria may also be defined according to the user metrics defined for the user 112 and that are used to determine whether to adjust the credit limit and/or security deposit associated with the secured payment instrument 116.

In an embodiment, if the secured payment instrument 116 can be graduated to an unsecured payment instrument, the graduation system 106 can provide the user 112 with an offer of graduation of the secured payment instrument 116 to an unsecured payment instrument. The offer for graduation includes information such as the terms for the graduation, an interest rate of the unsecured payment instrument, a credit limit of the unsecured payment instrument, when the graduation will be effective, whether the graduation is automatically accepted or automatically rejected based on no response by a certain date, and other such information. In an embodiment, the information (e.g., the terms for the graduation, an interest rate of the unsecured payment instrument, a credit limit of the unsecured payment instrument, when the graduation will be effective, whether the graduation is automatically accepted or automatically rejected based on no response by a certain date, etc.) included with the offer for graduation is provided to the user 112 at a time when the account and/or the secured payment instrument 116 is created. In an embodiment, the information included with the offer for graduation changes during the existence of the account and/or the secured payment instrument 116. Changes to this information may be communicated to the user 112 at a time when the changes occur. In such instances, the user 112 may have an opportunity to accept or reject the changes by, for example, submitting a request to cancel the account associated with the secured payment instrument 116.

In an embodiment, if the user 112 accepts the offer for graduation of the secured payment instrument 116 to an unsecured payment instrument, and an amount of the original security deposit is still associated with the secured payment instrument 116, the graduation system 106 retrieves the remaining security deposit associated with the secured payment instrument 116 for disbursement to the user 112. The graduation system 106 may provide the user 112 with one or more options for disbursement of the remaining security deposit (e.g., direct deposit to a financial account, pay down of an existing balance associated with the account, donation to charity, etc.). These options may be presented to the user 112, whereby the user 112 may select one or more disbursement options for disbursement of the remaining security deposit associated with the secured payment instrument 116. The graduation system 106 may further issue the unsecured payment instrument to the user 112. For instance, the graduation system 106 may automatically cancel the account associated with the secured payment instrument 116 and generate a new account that is to be associated with the unsecured payment instrument. Further, the graduation system 106 may provide the user 112 with the unsecured payment instrument, such as through mailing of a physical payment instrument corresponding to the unsecured payment instrument or providing executable instructions to associate a digital wallet with the new account corresponding to the unsecured payment instrument.

In an embodiment, the graduation system 106 continues to monitor the user's credit performance over time as the user 112 utilizes their unsecured payment instrument for different transactions in order to continuously, and in real-time, train the machine learning algorithm or artificial intelligence used to determine whether to adjust the credit limit and/or security deposit associated with secured payment instruments issued by the payment instrument service 102. For instance, if an offer for graduation of the secured payment instrument 116 to an unsecured payment instrument is provided to the user 112 based on adjustments to the credit limit and/or security deposit associated with secured payment instrument 116 made over time according to the user metrics defined for the user 112, and the user's credit performance subsequently declines (e.g., the user 112 has been delinquent in making payments towards balances associated with the unsecured payment instrument, the user 112 has not stayed on budget over a period of time, the user 112 has defaulted on various accounts, etc.), the graduation system 106 may assign a negative polarity to these user metrics and adjustments. This assignment of a negative polarity to these user metrics and adjustments may be used to retrain the machine learning algorithm or artificial intelligence such that, for similarly-situated users, the machine learning algorithm or artificial intelligence may assign more stringent user metrics for these users. These more stringent user metrics may make it more difficult for adjustments to be made to the credit limits and/or security deposits associated with these users' secured payment instruments. Alternatively, if the graduation system 106 determines that the user's credit performance has subsequently improved or otherwise has not declined over time, the graduation system 106 may assign a positive polarity to these user metrics and adjustments. This assignment of a positive polarity to these user metrics and adjustments may be used to reinforce the machine learning algorithm or artificial intelligence such that, for similarly-situated users, the machine learning algorithm or artificial intelligence may be more likely to assign similar user metrics and perform similar adjustments to the secured payment instruments associated with these similarly-situated users.

It should be noted that while machine learning algorithms or artificial intelligence may be implemented to determine user metrics usable to dynamically determine whether adjustments may be made to the credit limit and/or security deposit associated with a secured payment instrument, as well as to determine when to adjust the credit limit and/or security deposit associated with a secured payment instrument, the graduation system 106 may perform these determinations using other techniques. For example, the aforementioned user metrics may be pre-defined by the payment instrument service 102 and universal for users associated with the payment instrument service 102. Additionally, the thresholds utilized to determine what adjustment may be made to the credit limit and/or security deposit associated with a secured payment instrument may also be universal for the users associated with the payment instrument service 102. Thus, through the real-time monitoring of the transactions associated with a secured payment instrument 116 and of the credit performance of the user 112 (e.g., account holder), the graduation system 106 can automatically utilize the pre-defined user metrics and thresholds to determine if and when to adjust the credit limit and/or security deposit associated with the secured payment instrument 116.

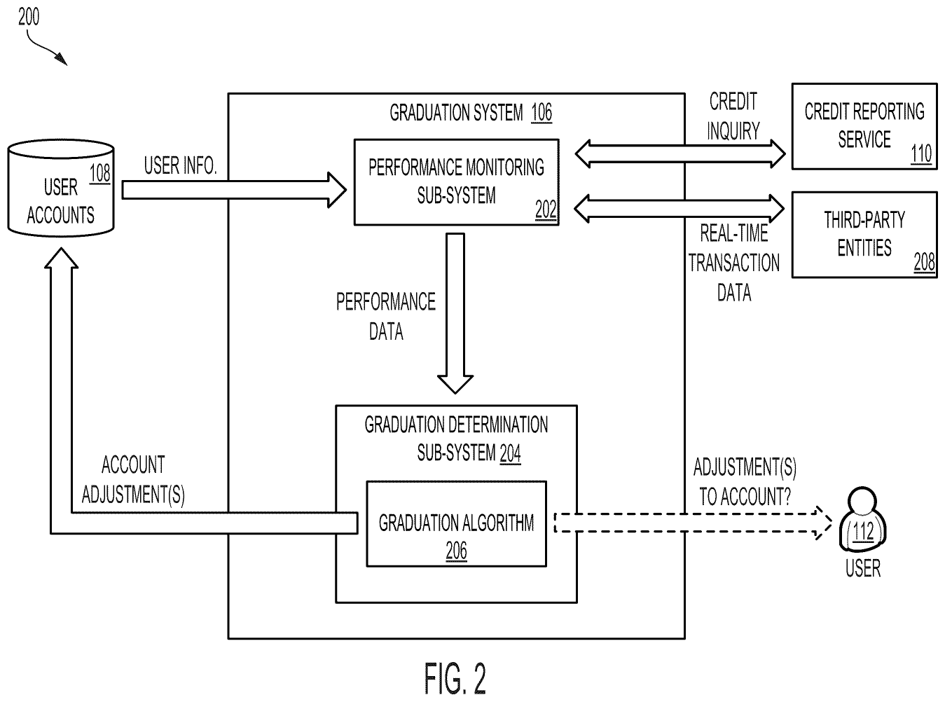

FIG. 2 shows an illustrative example of an environment 200 in which a graduation system 106 associated with a payment instrument service processes in real-time performance data associated with a secured payment instrument to determine whether to dynamically adjust a credit limit and/or a security deposit associated with the secured payment instrument in accordance with at least one embodiment. In the environment 200, a performance monitoring sub-system 202 implemented by the graduation system 106 may automatically, and in real-time, compile data associated with a secured payment instrument to generate performance data that may be used to determine whether one or more adjustments may be made to the credit limit and/or security deposit associated with the secured payment instrument. In an embodiment, the performance monitoring sub-system 202 retrieves, from the user accounts datastore 108, user information corresponding to an account holder (e.g., user 112) of the secured payment instrument. As noted above, an application submitted by the user 112 may include the user's legal name, birthdate, last four digits of their Social Security number, household income, and the like. This information may be stored within the user accounts datastore 108 in the form of user information. Thus, the performance monitoring sub-system 202 may obtain this user information from the user accounts datastore 108.

In an embodiment, using the obtained user information, the performance monitoring sub-system 202 may submit a credit inquiry to the credit reporting service 110 to obtain an updated credit evaluation for the user 112. The result of the credit inquiry may include one or more credit scores associated with the user 112, the current amount of credit allocated to the user 112 from different financial entities (including the payment instrument service), the current amount of credit available to the user 112, and the like. In response to obtaining this updated credit evaluation for the user 112, the performance monitoring sub-system 202 may automatically compare the updated credit evaluation to prior credit evaluations maintained within the user accounts datastore 108 to identify any changes to the user's credit performance. These changes may include changes to the user's credit scores, changes to the amount of available credit as a function of the total amount of credit allocated to the user 112, changes to the user's ability to pay down existing balances (e.g., any delinquencies, any defaults, etc.), and the like. These identified changes may be recorded by the performance monitoring sub-system 202 in the form of performance data.

In some instances, the performance monitoring sub-system 202 may automatically obtain credit evaluations associated with the user 112 in real-time from the credit reporting service 110 as changes to the user's credit performance are detected by the credit reporting service 110. For instance, rather than submitting a credit inquiry to the credit reporting service 110 in response to a triggering event (e.g., new transactions associated with the secured payment instrument, changes to the account associated with the secured payment instrument, etc.) or at pre-defined intervals, the credit reporting service 110 may automatically provide any changes to the user's credit performance as these changes occur. In an embodiment, the performance monitoring sub-system 202 maintains a data stream with the credit reporting service 110 through which the performance monitoring sub-system 202 can automatically obtain credit evaluations for users in real-time.

In addition to obtaining credit evaluations associated with the user 112 to identify any changes to the user's credit performance, the performance monitoring sub-system 202 may obtain, in real-time, transaction data associated with transactions corresponding to the secured payment instrument. The transaction data may be obtained in real-time from one or more third-party entities 208 as transactions corresponding to the secured payment instrument occur. For instance, if the user 112 uses their secured payment instrument to complete a purchase at a particular point-of-sale, the performance monitoring sub-system 202 may automatically obtain (such as through a transaction processing system associated with the payment instrument service) transaction data corresponding to this purchase. The transaction data may indicate the amount of the purchase, identity of the merchant or other entity from which the purchase was made, and the like. The one or more third-party entities 208 may include merchants, retailers, point-of-sale systems, other payment services (e.g., mobile payment services, peer-to-peer payment services, etc.), and the like.

In an embodiment, the performance monitoring sub-system 202 automatically compiles data corresponding to the user's credit performance and the transaction data from the one or more third-party entities 208 into performance data associated with the secured payment instrument. The performance data, as noted above, may include the user's credit performance over time based on a comparison of the user's current credit evaluation and historical credit performance recorded in the user accounts datastore 108 (e.g., changes to the user's credit scores, changes to the amount of available credit as a function of the total amount of credit allocated to the user 112, changes to the user's ability to pay down existing balances, etc.). Further, the performance data may specify any changes to the amount of available credit associated with the secured payment instrument as a result of new transactions involving use of the secured payment instrument. The performance data, in some examples, may further indicate spending trends associated with usage of the secured payment instrument. These spending trends may indicate changes in the user's spending habits that may correspond to the user's ability to remain within a budget or other measure of fiscal responsibility.

As noted above, the payment instrument service may define, for the user 112, a set of user metrics that may be used to determine whether adjustments may be made to the credit limit and/or security deposit associated with the secured payment instrument. These user metrics may correspond to real-time usage of the secured payment instrument over time. For example, a user metric may correspond to the user's ability to providing on-time payments for existing balances associated with the secured payment instrument over time. As another illustrative example, another user metric may correspond to the user 112 staying within a particular budget (e.g., maintaining a balance associated with the secured payment instrument below a particular threshold value, etc.) over a pre-defined period of time. User metrics may further be tied to rewards offered by the payment instrument service for using the secured payment instrument for different transactions (e.g., qualified purchases, promotional offers, etc.). In some instances, user metrics may also be tied to implementing one or more features associated with the secured payment instrument that may be used to better manage repayment of existing balances associated with the secured payment instrument (e.g., automatic payments, etc.). These user metrics may be maintained within the user accounts datastore 108 and may be obtained by the performance monitoring sub-system 202. Thus, in addition to the performance data, the performance monitoring sub-system 202 may retrieve the user metrics associated with the user 112 and provide these along with the performance data to a graduation determination sub-system 204.

In an embodiment, the graduation determination sub-system 204 implements a graduation algorithm 206 that is trained to automatically, and dynamically, determine whether an adjustment may be made to the credit limit and/or security deposit associated with a secured payment instrument based on the user metrics and the performance data associated with the secured payment instrument and a corresponding user. Additionally, based on any applicable adjustments, the graduation algorithm 206 may also determine whether the secured payment instrument may be graduated to an unsecured payment instrument. The graduation algorithm 206, in an embodiment, is a machine learning algorithm or artificial intelligence that is dynamically trained to perform the aforementioned operations. For instance, the graduation algorithm 206 may be trained using supervised, unsupervised, reinforcement, or other such training techniques. For instance, the graduation algorithm 206 may be trained using a dataset comprising sample user account information (e.g., sample user metrics, performance data, etc.) and adjustment records corresponding to the sample user account information (e.g., adjustments made to the credit limit and/or security deposit associated with a secured payment instrument, graduation offers made based on the adjustments, etc.). This dataset may be analyzed using the graduation algorithm 206 to identify correlations between different elements of the dataset without supervision and feedback.

As an example of a supervised training technique, a dataset can be selected for training of the graduation algorithm 206 to facilitate identification of correlations between user account information, performance data, and the adjustments made to the credit limits and/or security deposits associated with secured payment instruments. The graduation algorithm 206 may be evaluated to determine, based on the sample inputs supplied to the graduation algorithm 206, whether the graduation algorithm 206 is producing accurate correlations between members of the dataset (e.g., given a user's account information, performance data, and defined user metrics, the graduation algorithm 206 is making accurate adjustments (if any) to the credit limit and/or security deposit associated with the secured payment instrument). As an illustrative example of the training of the graduation algorithm 206, an evaluator of the graduation algorithm 206 may review the adjustments identified by the graduation algorithm 206 to determine whether these adjustments correspond to the user account information, performance data, and defined user metrics. To determine whether these adjustments are appropriate, the evaluator may evaluate feedback corresponding to these adjustments. This feedback may include later performance data associated with the secured payment instrument. The later performance data may indicate any changes in the user's credit performance as a result of the adjustments made to the credit limit and/or security deposit associated with the secured payment instrument and/or as a result of graduation of the secured payment instrument performed based on these adjustments. The evaluator, using this later performance data, may determine whether the adjustments made to the secured payment instrument are appropriate or otherwise consistent with the performance data and user account information. Accordingly, based on this evaluation, the evaluator may re-train and/or improve the graduation algorithm 206 to improve the likelihood of the graduation algorithm 206 conducting appropriate adjustments according to the received performance data and user account information associated with a secured payment instrument.

In an embodiment, the graduation algorithm 206 automatically, and in real-time, processes the performance data provided by the performance monitoring sub-system 202 to determine whether the credit limit and/or security deposit associated with a secured payment instrument issued to the user 112 may be adjusted. As noted above, the performance monitoring sub-system 202 may generate the performance data in real-time as transactions involving the secured payment instrument occur. Thus, the graduation algorithm 206 may also make a determination as to whether the credit limit and/or security deposit associated with a secured payment instrument may be adjusted as these transactions occur. Based on this real-time performance data, the graduation algorithm 206 may dynamically, and in real-time, determine whether any adjustments may be made to the credit limit and/or security deposit associated with the secured payment instrument issued to the user 112.

Returning to an illustrative example described above, if the graduation algorithm 206 determines that the user 112 has earned a cash back reward as a result of making on-time payments over a period of time, using their secured payment instrument for qualified transactions, staying within a pre-defined budget (as determined based on credit evaluations over time), and has established automatic payments for paying down existing balances associated with the secured payment instrument, the graduation algorithm 206 may automatically apply this cash back reward to the security deposit associated with the secured payment instrument to reduce the security deposit. As another example, if the graduation algorithm 206 determines that the credit limit associated with the secured payment instrument may be increased as a result of making on-time payments over a period of time, demonstrable improvements in credit performance over a period of time, staying within a pre-defined budget, and the like, the graduation algorithm 206 may automatically update the user accounts datastore 108 to reflect this change to the credit limit associated with the secured payment instrument.

In some instances, based on the real-time performance data and the user metrics associated with the user 112, the graduation system 106 may determine that both the credit limit and security deposit associated with the secured payment instrument may be adjusted concurrently. As noted above, the payment instrument service may define, for the user 112, different performance thresholds, whereby meeting or exceeding a particular performance threshold may result in different adjustments to the secured payment instrument. If the graduation algorithm 206 determines that the user's performance data is indicative of a substantial improvement in the user's credit performance beyond a particular performance threshold, the graduation algorithm 206 may both reduce the security deposit associated with the secured payment instrument and increase the credit limit associated with the secured payment instrument.

Any adjustments made to the credit limit and/or security deposit associated with the secured payment instrument may be communicated to the user 112 by the graduation algorithm 206, such as through an application or web portal provided by the payment instrument service. For instance, if the graduation algorithm 206 reduces the security deposit associated with the secured payment instrument based on an earned cash back reward, the graduation algorithm 206 may provide, through the application or web portal, an indication of the amount of cash back earned, as well as a breakdown of the cash back reward according to the various user metrics used by the graduation algorithm 206 to reduce the security deposit. Further, the graduation algorithm 206 may provide an indication of the new security deposit balance used to securitize the secured payment instrument. In some instances, the graduation algorithm 206 may also provide one or more disbursement options for the amount deducted from the security deposit associated with the security deposit, as described above. As another illustrative example, if the graduation algorithm 206 increases the credit limit associated with the secured payment instrument, the graduation algorithm 206 may provide, through the application or web portal, an indication of the new credit limit associated with the secured payment instrument. Additionally, the graduation algorithm 206 may provide a justification or other explanation for the increase in the credit limit associated with the secured payment instrument. For example, if the graduation algorithm 206 increases the credit limit associated with the secured payment instrument as a result of the user 112 continuing to make on-time payments and staying within a pre-defined budget over a period of time, the graduation algorithm 206 may generate an explanation to this effect.

In addition to determining whether to adjust the credit limit and/or security deposit associated with the secured payment instrument based on the real-time performance data associated with the user 112, the graduation algorithm 206 may also determine whether the secured payment instrument may be graduated to an unsecured payment instrument. For example, if the graduation algorithm 206 determines that the reduction in the security deposit used to securitize the secured payment instrument results in the elimination of the security deposit, the graduation algorithm 206 may determine that the secured payment instrument may be graduated to an unsecured payment instrument, as the secured payment instrument is no longer securitized. As another illustrative example, if the graduation algorithm 206 determines that a new ratio of the new credit limit to the amount of the security deposit associated with the secured payment instrument exceeds a graduation threshold value, the graduation algorithm 206 may determine that the secured payment instrument may be graduated to an unsecured payment instrument.

If the graduation algorithm 206 determines that the secured payment instrument may be graduated to an unsecured payment instrument, the graduation algorithm 206 may provide the user 112 with an offer of graduation of the secured payment instrument to an unsecured payment instrument. As noted above, if the user 112 accepts the offer for graduation of the secured payment instrument to an unsecured payment instrument, and an amount of the original security deposit is still associated with the secured payment instrument, the graduation algorithm 206 may retrieve the remaining security deposit associated with the secured payment instrument for disbursement to the user 112. The graduation algorithm 206 may further cause the graduation system 106 to issue the unsecured payment instrument to the user 112. The graduation system 106 may automatically cancel the account associated with the secured payment instrument and generate a new account that is to be associated with the unsecured payment instrument. Further, the graduation system 106 may provide the user 112 with the unsecured payment instrument.

As noted above, the user's credit performance may continue to be monitored by the performance monitoring sub-system 202 over time as the user 112 utilizes their unsecured payment instrument for different transactions. Performance data generated in real-time by the performance monitoring sub-system 202 as these transactions occur may be used to continuously, and in real-time, update the graduation algorithm 206. For example, if the secured payment instrument is graduated to an unsecured payment instrument based on adjustments made by the graduation algorithm 206, and the user's credit performance subsequently declines, the performance monitoring sub-system 202 may assign a negative polarity to these user metrics and adjustments. This assignment of a negative polarity to these user metrics and adjustments may be used to retrain the graduation algorithm 206 such that, for similarly-situated users, the graduation algorithm 206 assigns more stringent user metrics for these users in order to make it more difficult for adjustments to be made to the credit limits and/or security deposits associated with these users' secured payment instruments. Alternatively, if the performance monitoring sub-system 202 determines that the user's credit performance has subsequently improved or otherwise has not declined over time, the performance monitoring sub-system 202 may assign a positive polarity to these user metrics and adjustments. This assignment of a positive polarity to these user metrics and adjustments may be used to reinforce the graduation algorithm 206.

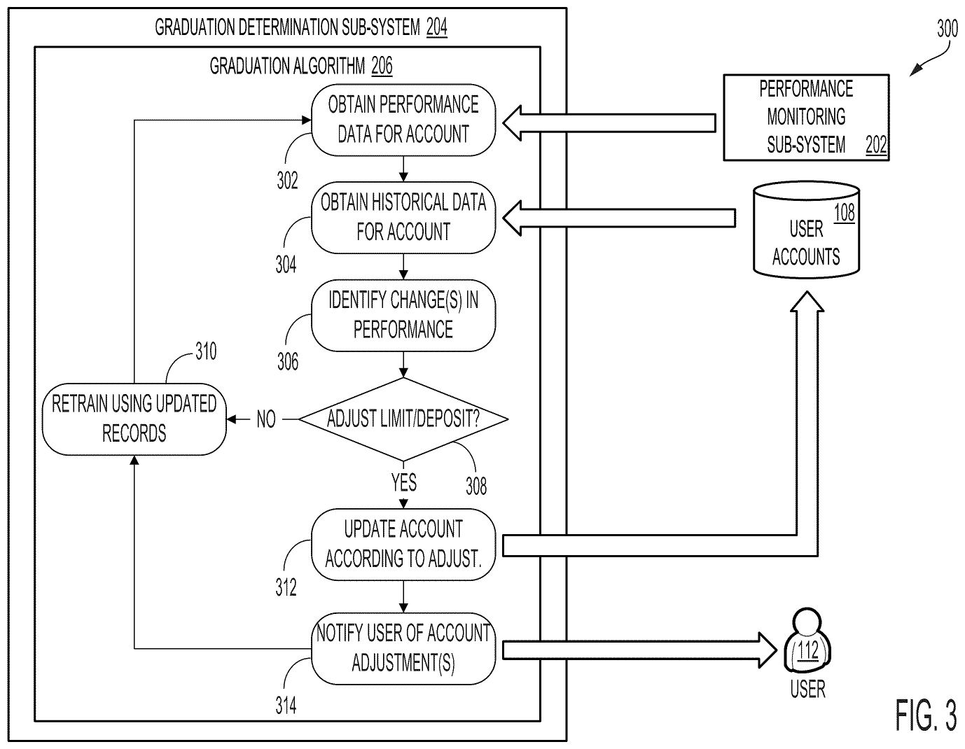

FIG. 3 shows an illustrative example of an environment 300 in which a graduation algorithm 206 automatically and in real-time processes performance and historical data associated with a secured payment instrument to determine whether to dynamically adjust a credit limit and/or a security deposit associated with the secured payment instrument in accordance with at least one embodiment. As noted above, a performance monitoring sub-system 202 may transmit, in real-time, performance data associated with a secured payment instrument issued to a user 112 to a graduation determination sub-system 204 to determine whether an adjustment to the credit limit and/or security deposit associated with the secured payment instrument may be performed. The graduation determination sub-system 204 may implement a graduation algorithm 206 that is dynamically trained to automatically determine whether to perform this adjustment to the credit limit and/or security deposit associated with the secured payment instrument based on user metrics associated with the user 112. Further, the graduation algorithm 206 may be dynamically trained to determine whether to provide the user 112 with an offer for graduation of the secured payment instrument to an unsecured payment instrument. The graduation algorithm 206, in some instances, may be configured to process the performance data and make any adjustments to the secured payment instrument in real-time as transactions associated with the secured payment instrument occur (e.g., as the user 112 utilizes the secured payment instrument for various transactions).

At step 302, the graduation algorithm 206 may obtain performance data corresponding to a user account associated with a secured payment instrument. As noted above, the performance monitoring sub-system 202 may obtain (in real-time, in response to a triggering event, or at pre-defined time intervals) a credit evaluation associated with the user 112. The performance monitoring sub-system 202 may compare this credit evaluation to previously obtained credit evaluations associated with the user 112 to identify any changes to the user's credit performance. These changes to the user's credit performance may include changes to the user's credit scores, changes to the amount of available credit as a function of the total amount of credit allocated to the user 112, changes to the user's ability to pay down existing balances (e.g., any delinquencies, any defaults, etc.), and the like. The performance data may further include transaction data associated with transactions corresponding to the secured payment instrument. This transaction data may be obtained in real-time from one or more third-party entities (e.g., merchants, retailers, point-of-sale systems, different payment services, etc.) as transactions involving the secured payment instrument occur. The performance monitoring sub-system may compile the user's credit evaluation and the transaction data into the performance data provided to the graduation algorithm 206.

At step 304, the graduation algorithm 206 may obtain, from the user accounts datastore 108, historical data corresponding to the user account associated with the secured payment instrument. The historical data may indicate previous adjustments made to the secured payment instrument (if any) based on changes to the user's credit performance and historical usage of the secured payment instrument for different transactions. Additionally, the historical data may include any user metrics previously determined for the user 112 based on an initial credit evaluation and data corresponding to other user accounts (e.g., other payment instruments issued to the user 112, financial accounts maintained by the user 112, etc.). As noted above, these user metrics may correspond to real-time usage of the secured payment instrument over time. For example, a user metric may correspond to the user's ability to providing on-time payments for existing balances associated with the secured payment instrument over time. As another illustrative example, another user metric may correspond to the user 112 staying within a particular budget (e.g., maintaining a balance associated with the secured payment instrument below a particular threshold value, etc.) over a pre-defined period of time. User metrics may further be tied to rewards offered by the payment instrument service for using the secured payment instrument for different transactions (e.g., qualified purchases, promotional offers, etc.). In some instances, user metrics may also be tied to implementing one or more features associated with the secured payment instrument that may be used to better manage repayment of existing balances associated with the secured payment instrument (e.g., automatic payments, etc.).

At step 306, the graduation algorithm 206 may automatically, and in real-time, identify any changes in the user's performance with regard to maintenance of the secured payment instrument and with regard to their overall credit. As noted above, the performance data may indicate any changes to the user's credit performance based on obtained credit evaluations associated with the user 112. Thus, from the performance data, the graduation algorithm 206 may automatically identify any changes to the user's credit scores, changes to the amount of available credit as a function of the total amount of credit allocated to the user 112, changes to the user's ability to pay down existing balances (e.g., any delinquencies, any defaults, etc.), and the like. Further, based on the obtained user metrics and the obtained performance data, the graduation algorithm 206 may identify possible adjustments that may be made to the credit limit and/or security deposit associated with the secured payment instrument. For instance, the graduation algorithm 206 may automatically, and in real-time, process the performance data according to the defined user metrics to calculate a cash back reward according to one or more categories corresponding to the user metrics. As an illustrative example, if a user metric is tied to rewards offered by the payment instrument service for using the secured payment instrument for certain qualified purchases, the graduation algorithm 206 may automatically process the performance data to identify any transactions corresponding to qualified purchases and calculate a cash back reward according to the defined user metric (e.g., 6% cash back reward, $0.30 cash back reward for each purchase over $10, etc.). As another illustrative example, if a user metric is tied to the user 112 implementing automatic payments for paying down existing balances associated with the secured payment instrument (e.g., $5 cash back reward for each month the user 112 is enrolled in automatic payments, etc.), the graduation algorithm 206 may automatically determine, from the performance data, whether the user 112 has implemented automatic payments and for what period of time. As another illustrative example, if a user metric is tied to a measurable improvement in the user's credit performance (e.g., $10 cash back reward for improving one or more credit scores by a pre-defined amount, $20 cash back reward for reducing existing balances associated with different lines of credit by a pre-defined amount, etc.), the graduation algorithm 206 may automatically process the performance data and the historical data to identify any changes to the user's credit performance and, based on the user metric, identify any rewards that the user 112 is eligible for.

In addition to identify possible adjustments to the security deposit associated with the secured payment instrument, the graduation algorithm 206 may automatically identify any possible adjustments to the credit limit associated with the secured payment instrument. For instance, based on the user metrics, the performance data associated with the secured payment instrument, and the historical data obtained from the user accounts datastore 108, the graduation algorithm 206 can determine whether the user 112 has been making on-time payments over a period of time, has provided demonstrable improvements in credit performance over a period of time, has stayed within a pre-defined budget, and the like. The user metrics may define different functions corresponding to possible adjustments to the user's credit limit associated with the secured payment instrument according to different criteria (e.g., making on-time payments, improving credit scores, maintaining a pre-defined budget, etc.) over time.

As noted above, the graduation algorithm 206 may be dynamically trained using a dataset comprising sample user account information (e.g., sample user metrics, performance data, etc.) and adjustment records corresponding to the sample user account information (e.g., adjustments made to the credit limit and/or security deposit associated with a secured payment instrument, graduation offers made based on the adjustments, etc.). This dataset may be analyzed using the graduation algorithm 206 to identify correlations between different elements of the dataset without supervision and feedback. As adjustments are made to the credit limits and/or security deposits associated with different secured payment instruments, feedback corresponding to later performance data associated with the secured payment instruments may be used to further train the graduation algorithm 206. As noted above, the later performance data may indicate any changes in users' credit performance as a result of the adjustments made to the credit limits and/or security deposits associated with the secured payment instruments and/or as a result of graduation of the secured payment instruments performed based on these adjustments. Using this later performance data, adjustments made to these secured payment instruments may be evaluated to determine whether these adjustments are appropriate or otherwise consistent with performance data and user account information. Accordingly, based on this evaluation, the graduation algorithm 206 may be re-trained and/or improved in order to improve the likelihood of the graduation algorithm 206 conducting appropriate adjustments according to the received performance data and user account information associated with a secured payment instrument. Further, the graduation algorithm 206 may be trained, according to this evaluation, to further refine the user metrics used to determine and make adjustments to credit limits and/or security deposits associated with secured payment instruments.

At step 308, based on its evaluation of the obtained performance data, the historical data associated with the secured payment instrument and the user 112, and the user metrics defined for the secured payment instrument, the graduation algorithm 206 may determine whether to adjust the credit limit and/or the security deposit associated with the secured payment instrument. For instance, if the graduation algorithm 206 determines, based on the performance data, the historical data associated with the secured payment instrument and the user 112, and the user metrics defined for the secured payment instrument that there has been no marked improvement in the credit performance associated with the user 112, the graduation algorithm 206 may determine that no adjustment is to be performed. In some instances, if the performance data is indicative of a degradation or stagnation in the user's performance, the graduation algorithm 206 may further dynamically adjust the user metrics associated with the user 112 in order to reduce the likelihood of an adjustment to the credit limit and/or security deposit associated with the secured payment instrument. This adjustment to the user metrics associated with the user 112 may further serve to incentivize the user 112 in making improvements to their credit performance, as the user 112 may be encouraged to restore the user metrics to their previous level and, thus, increase their credit limit and/or reduce the security deposit associated with the secured payment instrument.

If the graduation algorithm 206 determines that no adjustment is to be made to the credit limit and to the security deposit associated with the secured payment instrument, the graduation algorithm 206, at step 310, may be retrained using the updated records (e.g., the performance data obtained from the performance monitoring sub-system 202, any identified changes to the user's credit performance, any changes to the user metrics associated with the user account, the adjustment determination made by the graduation algorithm 206, etc.). This retraining of the graduation algorithm 206 may allow for continued refinement of the graduation algorithm 206 as new performance data is obtained in real-time for different secured payment instruments associated with different users. Thus, the graduation algorithm 206 may be retrained in real-time as the graduation algorithm 206 processes, simultaneously, real-time performance data for different secured payment instruments. Once the graduation algorithm 206 has been retrained according to the updated records, the graduation algorithm 206 may obtain new performance data for the user account associated with the secured payment instrument, providing an iterative and real-time process for determining whether to make adjustments to the credit limit and/or security deposit associated with a secured payment instrument.

If the graduation algorithm 206 determines that an adjustment may be made to the credit limit and/or the security deposit associated with the secured payment instrument, the graduation algorithm 206, at step 312, may update the user account associated with the secured payment instrument accordingly. For instance, the graduation algorithm 206 may update the user accounts datastore 108 to indicate the adjustment made to the credit limit and/or the security deposit associated with the secured payment instrument. Further, the graduation algorithm 206 may update the user account to incorporate the newly obtained performance data. In some instances, based on the adjustment made to the credit limit and/or the security deposit associated with the secured payment instrument, and the performance data associated with the user 112 and the secured payment instrument, the graduation algorithm 206 may further dynamically adjust the user metrics associated with the user 112 in order to maintain or increase the likelihood of an adjustment to the credit limit and/or security deposit associated with the secured payment instrument. In some instances, the user metrics may be dynamically adjusted to taper the possible adjustments that may be made to the credit limit and/or the security deposit associated with the secured payment instrument. This tapering may be performed in order to uphold a ceiling or cap to the amount of adjustments that may be made to the credit limit and/or security deposit associated with the secured payment instrument. For instance, if the credit limit associated with the secured payment instrument is adjusted to be two times the amount of the security deposit, the graduation algorithm 206 may adjust the user metrics such that no further adjustments may be made to the credit limit unless particular performance improvements are detected. As another illustrative example, if the security deposit associated with the secured payment instrument may only be decreased until the security deposit is, at a minimum, 50% of the credit limit associated with the secured payment instrument, the graduation algorithm 206 may dynamically adjust the user metrics such that the security deposit is not reduced below this minimum value unless particular performance improvements are detected. Thus, through the dynamic adjustment of user metrics based on performance data, the graduation algorithm 206 may provide granular tailoring of the possible adjustments that may be performed as the user's credit performance changes over time and draws nearer to graduation.

Once the graduation algorithm 206 has updated the user account according to the adjustments made to the credit limit and/or security deposit associated with the secured payment instrument, the graduation algorithm 206, at step 314, may notify the user 112 of any account adjustments performed by the graduation algorithm 206. For instance, through an application or web portal provided by the payment instrument service, the graduation algorithm 206 may communicate any adjustments made to the credit limit and/or security deposit associated with the secured payment instrument to the user 112. For instance, if the graduation algorithm 206 reduces the security deposit associated with the secured payment instrument based on an earned cash back reward, the graduation algorithm 206 may provide, through the application or web portal, an indication of the amount of cash back earned, as well as a breakdown of the cash back reward according to the various user metrics used by the graduation algorithm 206 to reduce the security deposit. Further, the graduation algorithm 206 may provide an indication of the new security deposit balance used to securitize the secured payment instrument. As another illustrative example, if the graduation algorithm 206 increases the credit limit associated with the secured payment instrument, the graduation algorithm 206 may provide, through the application or web portal, an indication of the new credit limit associated with the secured payment instrument. Additionally, the graduation algorithm 206 may provide a justification or other explanation for the adjustment made to the credit limit and/or the security deposit associated with the secured payment instrument. Additionally, the graduation algorithm 206, at step 310, may be retrained using the updated records (e.g., the performance data obtained from the performance monitoring sub-system 202, any identified changes to the user's credit performance, any changes to the user metrics associated with the user account, the adjustment determination made by the graduation algorithm 206, etc.), as described above.

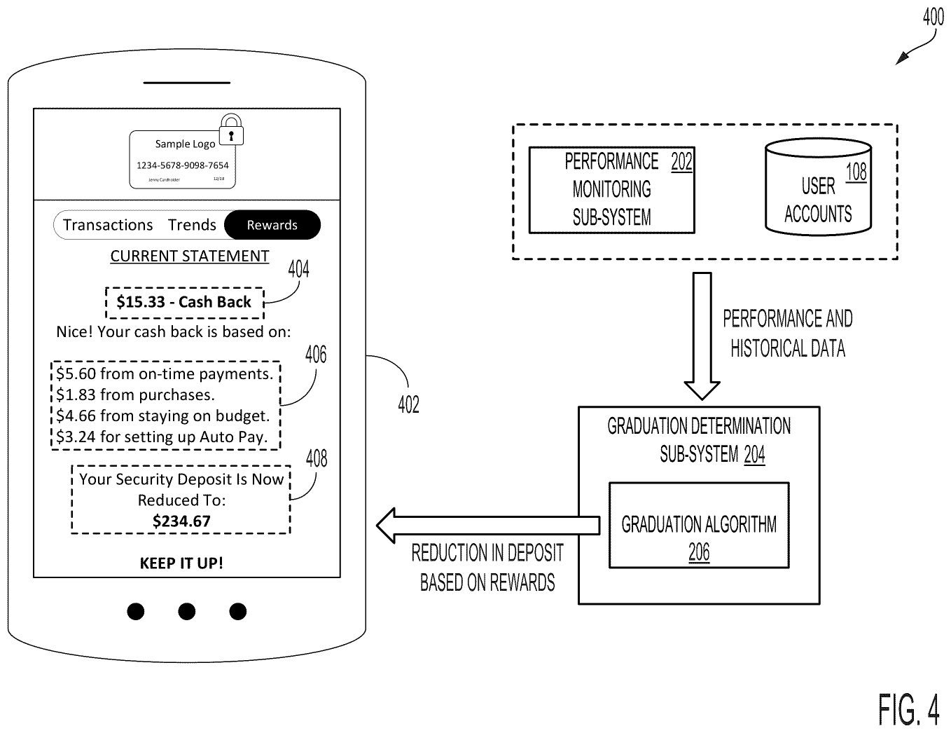

FIG. 4 shows an illustrative example of an environment 400 in which a graduation algorithm 206 dynamically and in real-time reduces a security deposit associated with a secured payment instrument based on rewards earned by an account holder in accordance with at least one embodiment. As noted above, the graduation determination sub-system 204 implements a graduation algorithm 206 that is dynamically trained to process, in real-time, performance and historical data associated with a secured payment instrument in order to determine whether any adjustments may be made to the credit limit and/or security deposit associated with the secured payment instrument. In the environment 400, the graduation algorithm 206 may automatically, and in real-time, obtain this performance and historical data from the performance monitoring sub-system 202 and the user accounts datastore 108, respectively.

As illustrated in FIG. 4, the graduation algorithm 206 has determined, based on a real-time evaluation of the performance and historical data associated with a secured payment instrument and the user metrics defined for an account holder of the secured payment instrument, that the security deposit associated with the secured payment instrument may be reduced by a particular amount. Returning to an earlier example, if the graduation algorithm 206 determines that a user (e.g., account holder) has earned a cash back reward as a result of making on-time payments over a period of time, using their secured payment instrument for qualified transactions, staying within a pre-defined budget (as determined based on credit evaluations over time), and having established automatic payments for paying down existing balances associated with the secured payment instrument, the graduation algorithm 206 may automatically apply this cash back reward to the security deposit associated with the secured payment instrument to reduce the security deposit. The cash back reward for each of these improvement categories may be determined according to the user metrics defined for the user account associated with the secured payment instrument.

Any adjustments made to the security deposit made by the graduation algorithm 206 based on the performance and historical data obtained from the performance monitoring sub-system 202 and the user accounts datastore 108 and the user metrics associated with the user account may be communicated to the user through an application or web portal provided by the payment instrument service. For example, as illustrated in FIG. 4, the graduation algorithm 206 may communicate the reduction in the security deposit associated with the secured payment instrument via an application implemented on a user device 402 (e.g., a smartphone, a laptop computer, a desktop computer, etc.). The reduction in the security deposit associated with the secured payment instrument may be communicated in the form of an account statement associated with the secured payment instrument. For instance, any reductions made to the security deposit associated with the secured payment instrument may be communicated to the user periodically according to a schedule for delivery of account statements (e.g., weekly, monthly, bi-monthly, etc.). Alternatively, any reductions made to the security deposit associated with the secured payment instrument may be communicated in real-time as these adjustments are made. For instance, if the graduation algorithm 206 reduces the security deposit associated with the secured payment instrument, the graduation algorithm 206 may automatically, and in real-time, transmit a notification indicating the reduction to the security deposit. The notification may be presented to the user via the user device 402, which the user may interact with in order to review the reduction made to the security deposit associated with the secured payment instrument.

As illustrated in FIG. 4, the graduation algorithm 206 may provide an indication of the cash back reward 404 earned by the user based on one or more user metrics associated with the user account. The cash back reward 404 may represent a total amount earned by the user over a period of time based on the performance and historical data processed by the graduation algorithm 206 according to the one or more user metrics associated with the user account. As noted above, the user metrics associated with the user account may correspond to real-time usage of the secured payment instrument over time. For example, a user metric may correspond to the user's ability to provide on-time payments for existing balances associated with the secured payment instrument over time. As another illustrative example, another user metric may correspond to the user staying within a particular budget (e.g., maintaining a balance associated with the secured payment instrument below a particular threshold value, etc.) over a pre-defined period of time. User metrics may further be tied to rewards offered by the payment instrument service for using the secured payment instrument for different transactions (e.g., qualified purchases, promotional offers, etc.). In some instances, user metrics may also be tied to implementing one or more features associated with the secured payment instrument that may be used to better manage repayment of existing balances associated with the secured payment instrument (e.g., automatic payments, etc.). Thus, the cash back reward 404 presented to the user may represent an aggregation of the different amounts earned by the user according to the aforementioned user metrics.

In addition to providing an indication of the total cash back reward 404 earned by the user based on the one or more user metrics associated with the user account, the graduation algorithm 206 may provide a breakdown 406 of the total cash back reward 404 according to the one or more user metrics. For example, as illustrated in FIG. 4, the graduation algorithm 206 may provide the amount of cash back earned by the user as a result of making on-time payments over a pre-defined period of time ($5.60). This amount of cash back may be automatically determined according to a function defined for the user according to the user's initial credit characteristics (e.g., initial credit scores, initial amount of available credit, initial amount of total credit allocated to the user, etc.). For example, as the user makes on-time payments to pay down existing balances associated with the secured payment instrument over time, the graduation algorithm 206 may automatically apply the aforementioned function to determine an amount of cash back that may be awarded to the user. The function may be defined such that the amount of cash back earned increases according to the consecutive periods of time (e.g., number of months, etc.) within which the user has made on-time payments towards existing balances or has otherwise maintained the secured payment instrument without an outstanding balance.

The breakdown 406 of the total cash back reward 404 may further include a cash back amount awarded based on purchases made using the secured payment instrument. As noted above, the graduation system 106 may automatically process the performance data to identify any transactions corresponding to qualified purchases and calculate a cash back reward according to the defined user metric. As an illustrative example, a user metric may be defined whereby a user may earn a 6% cash back reward for certain qualified purchases (e.g., certain grocery stores, certain merchants/retailers, etc.). As another illustrative example, a user metric may be defined whereby a certain amount of cash back may be rewarded for purchases over a particular amount (e.g., $0.30 cash back for each purchase over $10, etc.). The graduation algorithm 206 may automatically process the performance and historical data to identify any transactions that may correspond to qualified purchases that are eligible for a cash back reward. The graduation algorithm 206 may automatically use the user metrics (e.g., defined function for qualified purchases) to calculate the cash back reward for qualified purchases.

In some instances, the breakdown 406 of the total cash back reward 404 may further include a cash back amount corresponding to the user's continued ability to stay within a pre-defined budget over a period of time. As noted above, the graduation algorithm 206 may automatically process the performance and historical data to determine whether the user has been staying within a particular budget (e.g., maintaining a balance associated with the secured payment instrument below a particular threshold value, etc.) over a pre-defined period of time. The pre-defined period of time and the parameters associated with the particular budget (e.g., the particular threshold value, the amount of variance associated with the balance permitted, etc.) may be defined using one or more user metrics associated with the secured payment instrument. These particular user metrics may be defined by the graduation algorithm 206 based on an initial evaluation of the user's credit performance. Alternatively, these particular user metrics may be defined by the payment instrument service as universal user metrics applicable to all users associated with the payment instrument service (e.g., universal definition of the threshold value for balance management, universal period of time for maintaining a balance below the threshold value, etc.). The amount of cash back that may be rewarded to the user may also be defined according to the applicable user metrics, whereby the user metrics may define a function or set value that may be used to determine the amount of cash back. For example, for each month that the user is able to stay within a pre-defined budget, the amount of cash back that may be awarded may increase up to a maximum amount per time period (e.g., week, month, statement period, etc.). Thus, based on the user metrics and the performance and historical data, the graduation algorithm 206 may calculate the amount of cash back that may be rewarded for staying within a pre-defined budget over a period of time.

The breakdown 406 of the total cash back reward 404 may further include a cash back amount that may be awarded to the user for implementing one or more features associated with the secured payment instrument that may be used to better manage repayment of existing balances associated with the secured payment instrument. For instance, the graduation algorithm 206 may process the performance and historical data according to a user metric corresponding to the user's implementation of the aforementioned one or more features. As an illustrative example, if a user metric defines a function whereby the user may earn a $5 cash back reward for each month the user is enrolled in automatic payments, the graduation algorithm 206 may automatically determine, from the performance and historical data, whether the user has implemented automatic payments and for what period of time. Based on this determination, the graduation algorithm 206 may automatically determine the cash back amount that may be awarded to the user based on their implementation of the one or more features.

It should be noted that the different cash back amounts presented in the breakdown 406 of the total cash back reward 404 presented in FIG. 4 is an illustrative example and additional and/or alternative cash back categories may be represented in the breakdown 406 based on the user metrics defined for the particular user and the determinations made by the graduation algorithm 206 based on the real-time processing of the performance and historical data associated with the secured payment instrument. For instance, the graduation algorithm 206 may determine a cash back amount based on a user metric tied to a measurable improvement in the user's credit performance, whereby the cash back amount may correspond to the user's improvement of one or more credit scores by a pre-fined amount.

As noted above, any cash back rewards earned by the user according to the one or more user metrics associated with the user's secured payment instrument may be used to automatically reduce the security deposit used to securitize the secured payment instrument. As illustrated in FIG. 4, the total cash back reward 404 (e.g., $15.33) is used to reduce the security deposit to a new amount (e.g., $234.67 from $250, represented as a remaining security deposit amount 408). In some instances, the user metrics used to determine the cash back amounts according to different categories may be dynamically adjusted to taper the possible adjustments that may be made to the security deposit associated with the secured payment instrument, such as to uphold a cap to the amount of adjustments that may be made to the security deposit. Referring to a previously provided example, if the security deposit associated with the secured payment instrument may only be decreased until the security deposit is, at a minimum, 50% of the credit limit associated with the secured payment instrument, the graduation algorithm 206 may dynamically adjust the user metrics such that the security deposit is not reduced below this minimum value unless particular performance improvements are detected. Thus, the user metrics utilized to determine the total amount of cash back reward 404 that may be awarded to the user and used to reduce the security deposit may be dynamic in nature.

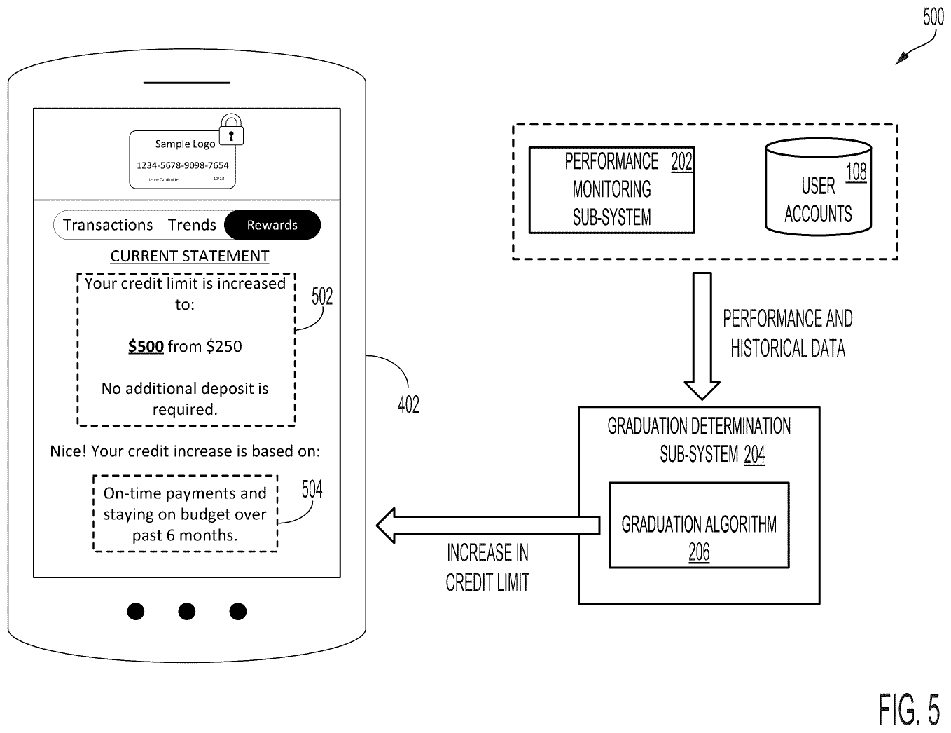

FIG. 5 shows an illustrative example of an environment 500 in which a graduation algorithm 206 dynamically and in real-time increases a credit limit associated with a secured payment instrument based on an improvement in account holder performance over time in accordance with at least one embodiment. Returning to an earlier example, if the graduation algorithm 206 determines that a user (e.g., account holder) has earned an increase in the credit limit associated with their secured payment instrument demonstrable improvements in credit performance over a period of time, staying within a pre-defined budget, and the like, the graduation algorithm 206 may automatically determine, based on one or more user metrics, an amount by which the credit limit associated with the secured payment instrument may be increased. This increase to the credit limit associated with the secured payment instrument may be performed according to the user metrics associated with the user without requiring an additional security deposit.

Similar to the presentation of adjustments made to a security deposit associated with the secured payment instrument described above in connection with FIG. 4, any adjustments made to the credit limit associated with the secured payment instrument made by the graduation algorithm 206 based on the performance and historical data obtained from the performance monitoring sub-system 202 and the user accounts datastore 108 and the user metrics associated with the user account may be communicated to the user through an application or web portal provided by the payment instrument service. For example, as illustrated in FIG. 5, the graduation algorithm 206 may communicate the increase in the credit limit associated with the secured payment instrument via an application implemented on the user device 402. The increase in the credit limit associated with the secured payment instrument may be communicated in the form of an account statement associated with the secured payment instrument. Alternatively, any adjustments to the credit limit associated with the secured payment instrument may be communicated in real-time as these adjustments are made.

As illustrated in FIG. 5, the graduation algorithm 206 may provide an indication of the credit limit increase 502 earned by the user based on one or more user metrics associated with the user account. The credit limit increase 502 may correspond to improvements to the user's credit performance, as determined based on the performance and historical data processed by the graduation algorithm 206 according to the one or more user metrics associated with the user account. As noted above, the user metrics associated with the user account may correspond to real-time usage of the secured payment instrument over time. For instance, these user metrics may correspond to making on-time payments over a period of time, demonstrable improvements in credit performance over a period of time, staying within a pre-defined budget, and the like. Based on the performance and historical data, and according to the user metrics associated with the secured payment instrument, the graduation system 106 may automatically update the user accounts datastore 108 to reflect the increase to the credit limit associated with the secured payment instrument.

As an illustrative example, based on a real-time evaluation of the performance and historical data associated with the secured payment instrument according to the one or more user metrics associated with the secured payment instrument, the graduation system 106 may increase the credit limit from $250 to $500, as illustrated in FIG. 5 through the credit limit increase 502. As noted above, this increase to the credit limit associated with the secured payment instrument may be performed without requiring an additional security deposit. Thus, through the credit limit increase 502, the graduation algorithm 206 may indicate, to the user, that no additional security deposit is required for the secured payment instrument.

In an embodiment, the graduation algorithm 206 can additionally provide to the user a justification or other explanation for the increase in the credit limit associated with the secured payment instrument. As illustrated in FIG. 5, this justification or other explanation may be presented via an explanation window 504 associated with the application implemented on the user device 402. For example, the graduation algorithm 206 may indicate that the increase to the credit limit associated with the secured payment instrument was awarded to the user as a result of the user continuing to make on-time payments and staying within a pre-defined budget over six-month period.

It should be noted that while adjustments to the security deposit and the credit limit associated with a secured payment instrument are illustrated in FIGS. 4 and 5 as being presented via separate interfaces, any adjustments made to the security deposit and/or credit limit associated with a secured payment instrument may be presented via a single interface. As noted above, there may be instances where, based on the real-time performance data and the user metrics associated with the user, the graduation system 106 may determine that both the credit limit and security deposit associated with the secured payment instrument may be adjusted concurrently. For example, if the graduation algorithm 206 determines that the user's performance data is indicative of a substantial improvement in the user's credit performance beyond a particular performance threshold, the graduation algorithm 206 may both reduce the security deposit associated with the secured payment instrument and increase the credit limit associated with the secured payment instrument. These adjustments to the security deposit and credit limit associated with the secured payment instrument may be presented concurrently through a single interface as opposed to individual interfaces, such as those represented in FIGS. 4 and 5.

Similar to the adjustments that may be made to the security deposit associated with the secured payment instrument, the graduation system 106 may further impose a ceiling or cap to the amount of adjustments that may be made to the credit limit associated with the secured payment instrument. To impose this ceiling or cap to the adjustments that may be made to the credit limit, the graduation system 106 may dynamically adjust the user metrics associated with the secured payment instrument. For instance, if the credit limit associated with the secured payment instrument is adjusted to be two times the amount of the security deposit, the graduation algorithm 206 may adjust the user metrics such that no further adjustments may be made to the credit limit unless particular performance improvements are detected.

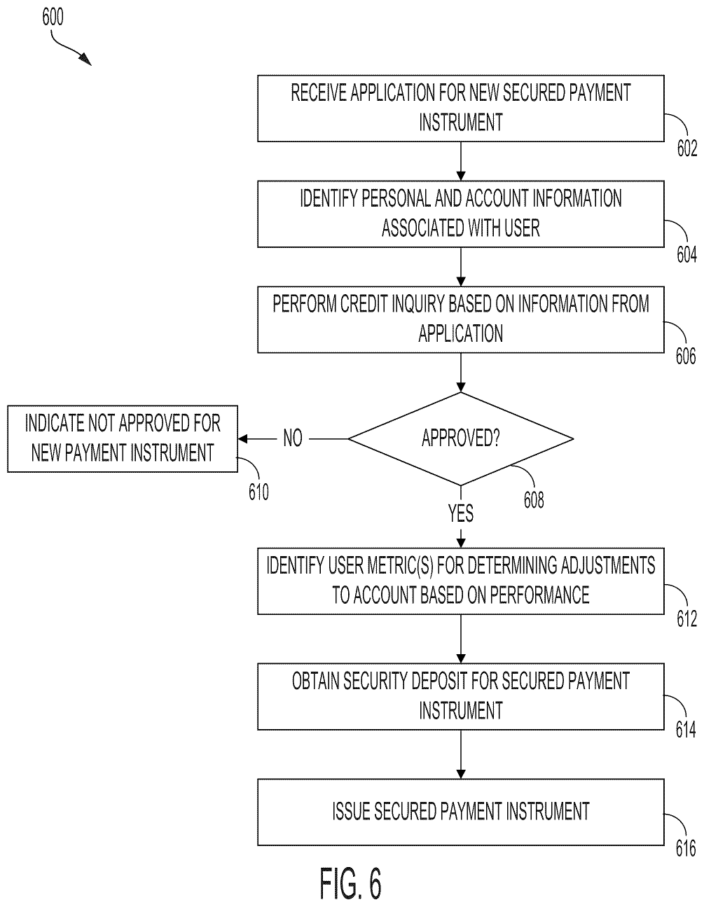

FIG. 6 shows an illustrative example of a process 600 for issuing a secured payment instrument based on a received application and a corresponding credit evaluation in accordance with at least one embodiment. The process 600 may be performed by the aforementioned payment instrument application system implemented by the payment instrument service. As noted above, the payment instrument application system is implemented to process incoming applications for secured payment instruments that may be securitized using a security deposit maintained in escrow by the payment instrument service.

At step 602, the payment instrument application system may receive an application for a new secured payment instrument. The application may include information that may be used to perform a credit inquiry of the user's credit report to determine whether the user is qualified for a line of credit associated with a secured payment instrument. For instance, through the application or other request, the user may provide their legal name, birthdate, last four digits of their Social Security number, household income, and the like. As noted above, the user (e.g., applicant) may also be associated with an existing account associated with the payment instrument service. This existing account may correspond to one or more existing lines of credit associated with other secured and/or unsecured payment instruments made available by the payment instrument service. Through this existing account, the payment instrument application system may automatically obtain any additional information that may be used to automatically supplement the obtained application. Thus, through processing of this application, the payment instrument application system may identify personal and account information associated with the user at step 604.

At step 606, the payment instrument application system may perform an initial credit inquiry based on the information provided in the application and from the user's pre-existing account (if available). For instance, using the obtained information, the payment instrument application system may automatically submit a credit inquiry to a credit reporting service in order to obtain a credit evaluation for the user. The result of the credit inquiry may include one or more credit scores associated with the user, the current amount of credit allocated to the user from different financial entities (including the payment instrument service, if any), the current amount of credit available to the user, and the like.

Based on the result of the credit inquiry, the payment instrument application system, at step 608, may determine whether the user is approved for a new line of credit associated with a secured payment instrument. In an embodiment, the payment instrument application system implements a machine learning algorithm or artificial intelligence to determine whether the user is approved for the new line of credit. The machine learning algorithm or artificial intelligence may be implemented to automatically, and dynamically, evaluate the applications submitted by users for new lines of credit, as well as these users' credit histories as provided by one or more credit reporting services, to determine whether these users are approved for these new lines of credit. For instance, for the user that submitted the application, the machine learning algorithm or artificial intelligence may process the provided application, the result of the credit inquiry, and any existing user records from the user accounts datastore (such as the user accounts datastore 108 described above in connection with FIG. 1) to determine whether the user is approved for the new line of credit. For instance, based on the user's credit history, characteristics of the user (e.g., demographic information, etc.), and information provided in the application (e.g., current income, employment status, current employment title, length of employment, etc.), the machine learning algorithm or artificial intelligence may identify similarly situated users according to one or more vectors of similarity (e.g., credit scores, changes in credit scores, spending habits, total amount of credit allocated, total amount of credit available, payment performance, demographic information, etc.). These similarly situated users may correspond to secured payment instruments issued to these account holders and/or to applications that have been rejected based on the one or more vectors of similarity. The machine learning algorithm or artificial intelligence, in some instances, may analyze a dataset of characteristics of users and accounts to determine whether to approve or reject the submitted application. This dataset may include historical data corresponding to the applications for new lines of credit submitted by different users, the decisions made in response to these applications (e.g., approve or deny), the users' performance in maintaining the lines of credit associated with these payment instruments in good standing, historical changes to the users' credit scores while maintaining these lines of credit, and the like.

At step 610, if the payment instrument application system determines that the user is not approved for a new line of credit associated with a secured payment instrument, the payment instrument application system may indicate that the user has not been approved for the applied for secured payment instrument. For instance, the payment instrument application system may transmit a notification to the user to indicate that the user has not been approved for the new line of credit. In some instances, the payment instrument application system may further provide the user with a rationale for the rejection of their application for the new line of credit. For example, if the user was rejected due to a poor credit score and a history of payment delinquencies, the payment instrument application system may generate a response that indicates that the poor credit score and the user's past history were contributing factors to the application being rejected. In some instances, any rationale provided may omit any specific metrics leading to rejection of the application. For example, the payment instrument application system may omit actual credit score values, descriptions of individual events corresponding to negative contributing factors towards rejection, and the like.

At step 612, if the payment instrument application system determines that the user is approved for a new line of credit associated with a secured payment instrument, the payment instrument application system may identify a set of user metrics that may be implemented to dynamically determine adjustments that may be made to the credit limit and/or security deposit associated with the secured payment instrument based on the credit performance associated with the user. As noted above, these user metrics may correspond to real-time usage of the secured payment instrument over time. For example, a user metric may correspond to the user's ability to provide on-time payments for existing balances associated with the secured payment instrument over time. As another illustrative example, another user metric may correspond to the user staying within a particular budget over a pre-defined period of time. User metrics may further be tied to rewards offered by the payment instrument service for using the secured payment instrument for different types of transactions. In some instances, user metrics may also be tied to implementing one or more features associated with the secured payment instrument that may be used to better manage repayment of existing balances associated with the secured payment instrument.

The payment instrument application system, in some instances, may implement a machine learning algorithm or artificial intelligence that is used to automatically identify the set of user metrics that may be implemented to dynamically determine the aforementioned adjustments. The machine learning algorithm or artificial intelligence may be trained to identify correlations amongst users to create a set of clusters that may be used to identify similar account holders and corresponding payment instruments based on one or more vectors (e.g., credit scores, changes in credit scores, spending habits, total amount of credit allocated, total amount of credit available, payment performance, demographic information, payment instruments issued, payment instruments in default, etc.). These similar account holders may correspond to the different payment instruments issued to these account holders and identification of corresponding user metrics based on the one or more vectors, as well as to the performance of these account holders in maintaining their accounts. Through implementation of the machine learning algorithm or artificial intelligence, the payment instrument application system may identify a particular cluster of similarly situated users from which a set of user metrics may be identified.

As noted above, the payment instrument application system may provide the user with information corresponding to the amount of the line of credit and of the security deposit required for the secured payment instrument. For instance, if the user submitted their application for a new secured payment instrument through an application or web portal provided by the payment instrument service, the payment instrument application system may update a user interface associated with the application or web portal to present the amount of the line of credit, the required security deposit, and any other information associated with the secured payment instrument (e.g., terms and conditions, interest rates, re-payment schedules, user metrics for dynamic adjustment of the credit limit and/or security deposit, etc.). If the user agrees to the terms and conditions associated with the secured payment instrument, the payment instrument application system may, at step 614, obtain the security deposit required for securitizing the secured payment instrument. Further, once the security deposit has been obtained, the payment instrument application system may, at step 616, issue the secured payment instrument to the user.

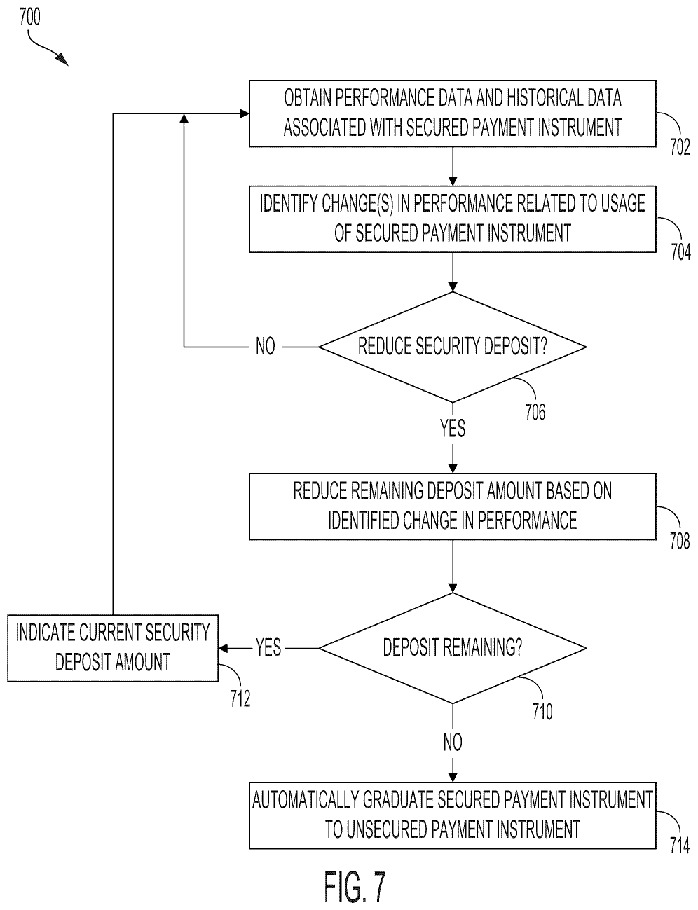

FIG. 7 shows an illustrative example of a process 700 for dynamically and in real-time reducing a security deposit associated with a secured payment instrument based on changes in performance related to real-time usage of the secured payment instrument in accordance with at least one embodiment. The process 700 may be performed by a graduation system associated with the payment instrument service. As noted above, the graduation system may implement a graduation algorithm that is dynamically trained to automatically determine whether an adjustment may be made to the credit limit and/or security deposit associated with a secured payment instrument based on the user metrics and the performance data associated with the secured payment instrument and a corresponding user. Additionally, based on any applicable adjustments, the graduation algorithm may also determine whether the secured payment instrument may be graduated to an unsecured payment instrument.

At step 702, the graduation system may obtain performance and historical data associated with a secured payment instrument. For instance, the graduation system may obtain a credit evaluation for a user associated with the secured payment instrument. The credit evaluation may indicate one or more credit scores associated with the user, the current amount of credit allocated to the user from different financial entities (including the payment instrument service, if any), the current amount of credit available to the user, and the like. Additionally, the graduation system may monitor, in real-time, transactions associated with the secured payment instrument as these transactions occur. For instance, when a user utilizes their secured payment instrument to make a purchase at a point-of-sale, information corresponding to this purchase may be obtained, in real-time, by the graduation system. The historical data obtained by the graduation system may include previously obtained credit evaluations associated with the user, trends corresponding to usage of the secured payment instrument over time (e.g., frequency of use, balances over time, etc.), and any user metrics that may be used to determine whether to adjust the security deposit associated with the secured payment instrument. The historical data may further indicate previous adjustments made to the secured payment instrument (if any) based on changes to the user's credit performance and historical usage of the secured payment instrument for different transactions.

At step 704, the graduation system, through implementation of the graduation algorithm, may identify any changes in performance related to usage of the secured payment instrument. For instance, the graduation system may compare the obtained credit evaluation to previously obtained credit evaluations associated with the user to identify any changes to the user's credit performance. These changes to the user's credit performance may include changes to the user's credit scores, changes to the amount of available credit as a function of the total amount of credit allocated to the user, changes to the user's ability to pay down existing balances, and the like. In addition to identify any changes to the user's credit performance, the graduation system may further identify any changes to the trends corresponding to usage of the secured payment instrument. These changes may correspond to variability in the usage of the secured payment instrument for different transactions.

In an embodiment, the graduation system, through implementation of the graduation algorithm, processes the performance data automatically and in real-time according to the defined user metrics to determine, at step 706, whether to reduce a security deposit associated with the secured payment instrument. For instance, the graduation system may automatically, and in real-time, process the performance data according to the defined user metrics to calculate a cash back reward according to one or more categories corresponding to the user metrics. For instance, if a particular user metric is tied to rewards offered by the payment instrument service for using the secured payment instrument for certain qualified purchases, the graduation system may automatically process the performance data to identify any transactions corresponding to qualified purchases and calculate a cash back reward according to the defined user metric. As another example, if a user metric is tied to the user implementing automatic payments for paying down existing balances associated with the secured payment instrument, the graduation system may automatically determine, from the performance data, whether the user has implemented automatic payments and for what period of time. As an additional example, if a user metric is tied to a measurable improvement in the user's credit performance, the graduation system may automatically process the performance data and the historical data to identify any changes to the user's credit performance and, based on the user metric, identify any rewards that the user is eligible for.

If the graduation system determines that the security deposit is not to be reduced as a result of the change in performance related to usage of the secured payment instrument, the graduation system may maintain the current security deposit requirement and continue to process performance data and historical data associated with the secured payment instrument, thereby restarting the process 700. For instance, if the graduation system determines that there has been no marked improvement in the credit performance associated with the user, the graduation system may determine that no adjustment is to be performed. In some instances, if the performance data is indicative of a degradation or stagnation in the user's performance, the graduation system may further dynamically adjust the user metrics associated with the user in order to reduce the likelihood of an adjustment to the security deposit associated with the secured payment instrument. It should be noted that even if no adjustments are made to the security deposit associated with the secured payment instrument, the graduation system may continue to obtain and process performance data and historical data associated with the secured payment instrument in real-time and as transactions involving the secured payment instrument occur in order to automatically identify any opportunities for reduction of the security deposit.

If the graduation system determines that the security deposit may be reduced based on the identified changes in performance related to usage of the secured payment instrument, the graduation system may automatically, at step 708, reduce the remaining security deposit amount associated with the secured payment instrument based on these identified changes. For example, the graduation system may reduce the security deposit according to a cash back reward earned by the user based on the obtained performance data, historical data, and the one or more user metrics associated with the user account. The cash back reward may represent a total amount earned by the user over a period of time according to the one or more user metrics associated with the user account. Thus, the cash back reward may represent an aggregation of the different amounts earned by the user according to the aforementioned user metrics.

As noted above, based on the adjustment made to the security deposit associated with the secured payment instrument, and the performance data associated with the user and the secured payment instrument, the graduation system may dynamically adjust the user metrics associated with the user in order to maintain or increase the likelihood of an adjustment to the security deposit associated with the secured payment instrument. In some instances, the user metrics may be dynamically adjusted to taper the possible adjustments that may be made to the credit limit and/or the security deposit associated with the secured payment instrument. This tapering may be performed in order to uphold a ceiling or cap to the amount of adjustments that may be made to the security deposit associated with the secured payment instrument. For example, if the security deposit associated with the secured payment instrument may only be decreased until the security deposit is, at a minimum, 50% of the credit limit associated with the secured payment instrument, the graduation system may dynamically adjust the user metrics such that the security deposit is not reduced below this minimum value unless particular performance improvements are detected.

Once the security deposit has been reduced according to the identified change in performance, the graduation system may determine, at step 710, whether there is any amount of the security deposit remaining for securitization of the secured payment instrument. If the graduation system determines that the secured payment instrument is still securitized by at least a portion of the original security deposit amount, the graduation system, at step 712, may indicate the new (e.g., current) security deposit amount associated with the secured payment instrument. For instance, through an interface (e.g., GUI) provided by the payment instrument service (such as through an application or web portal provided by the payment instrument service), the graduation system may provide a breakdown of the cash back reward earned by the user based on their performance data and the new security deposit amount associated with the secured payment instrument. The reduction to the security deposit amount may correspond to the breakdown of the cash back reward earned by the user, whereby the previous security deposit amount is reduced according to the cash back reward. Once the security deposit has been reduced according to the performance data associated with the user, the graduation system may continue to process performance data and historical data associated with the secured payment instrument, thereby restarting the process 700.

If the graduation system determines that the secured payment instrument is no longer securitized by a security deposit (e.g., there is no security deposit remaining after the identified reduction), the graduation system, at step 714, may automatically graduate the secured payment instrument to an unsecured payment instrument. For instance, the graduation system may transmit a notification to the user to indicate that the secured payment instrument is being graduated to an unsecured payment instrument. Further, the graduation system may provide the user with the unsecured payment instrument, such as through mailing of a physical payment instrument corresponding to the unsecured payment instrument or providing executable instructions to associate a digital wallet with the new account corresponding to the unsecured payment instrument. In addition to issuing the unsecured payment instrument to the user, the graduation system may automatically cancel the account associated with the secured payment instrument and generate a new account that is to be associated with the unsecured payment instrument.

In some instances, graduation of the secured payment instrument to an unsecured payment instrument may be contingent on the user's approval to such a graduation. For example, if the graduation system determines that the secured payment instrument may be graduated to an unsecured payment instrument as a result of the security deposit being completely diminished as a result of adjustments made to the security deposit, the graduation system may provide the user with an offer of graduation. The offer for graduation may include information such as the terms for the graduation, an interest rate of the unsecured payment instrument, a credit limit of the unsecured payment instrument, when the graduation will be effective, whether the graduation is automatically accepted or automatically rejected based on no response by a certain date, and other such information. If the user accepts the offer for graduation, the graduation system may perform the aforementioned operations described above in connection with step 714 for graduating the secured payment instrument to an unsecured payment instrument.

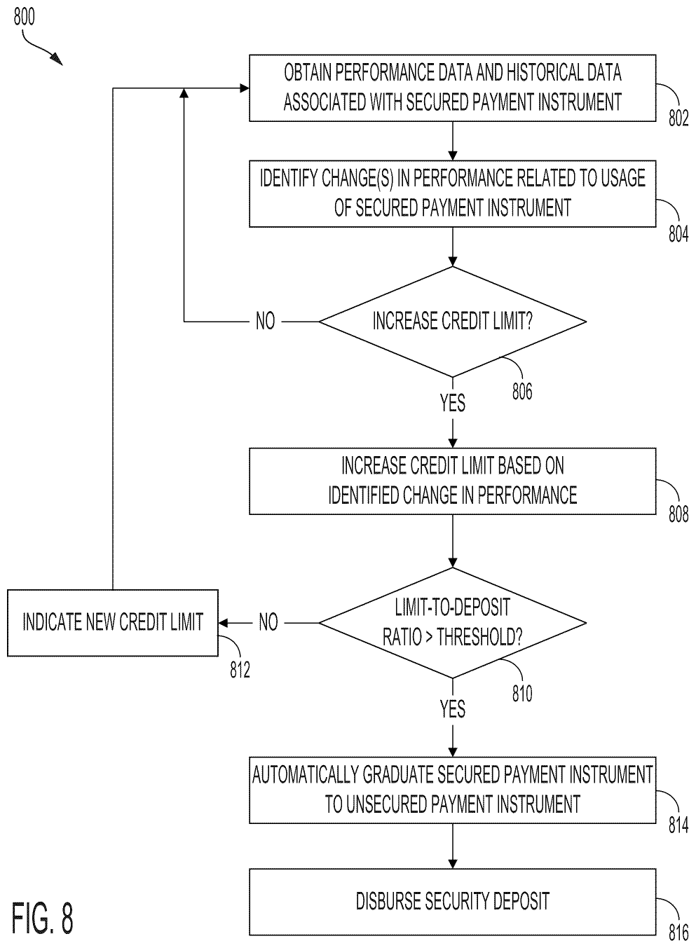

FIG. 8 shows an illustrative example of a process 800 for dynamically and in real-time adjusting a credit limit associated with a secured payment instrument based on changes in performance related to real-time usage of the secured payment instrument in accordance with at least one embodiment. Similar to the process 700 described above in connection with FIG. 7, the process 800 may be performed by a graduation system associated with the payment instrument service. For instance, the graduation system may implement a graduation algorithm that is dynamically trained to automatically determine whether an adjustment may be made to the credit limit associated with a secured payment instrument based on the user metrics and the performance data associated with the secured payment instrument and a corresponding user. Additionally, based on any applicable adjustments, the graduation algorithm may also determine whether the secured payment instrument may be graduated to an unsecured payment instrument.

As with the process 700 described above, the graduation system may, at step 802, obtain performance data and historical data associated with the secured payment instrument. Further, at step 804, the graduation system may identify any changes in the performance related to usage of the secured payment instrument. In an embodiment, the graduation system, through implementation of the graduation algorithm, processes the performance data automatically and in real-time according to a set of defined user metrics to determine, at step 806, whether to increase a credit limit associated with the secured payment instrument. For instance, based on the user metrics, the performance data associated with the secured payment instrument, and the obtained historical data, the graduation system can determine whether the user has been making on-time payments over a period of time, has provided demonstrable improvements in credit performance over a period of time, has stayed within a pre-defined budget, and the like. The user metrics may define different functions corresponding to possible adjustments to the user's credit limit associated with the secured payment instrument according to different criteria (e.g., making on-time payments, improving credit scores, maintaining a pre-defined budget, etc.) over time.

If the graduation system determines that no adjustment is to be made to the credit limit associated with the secured payment instrument, the graduation system may maintain the current credit limit associated with the secured payment instrument and continue to process performance data and historical data associated with the secured payment instrument, thereby restarting the process 800. Similar to the process 700 described above, if the graduation system determines that there has been no marked improvement in the credit performance associated with the user, the graduation system may determine that no adjustment to the credit limit associated with the secured payment instrument is to be performed. It should be noted that even if no adjustments are made to the credit limit associated with the secured payment instrument, the graduation system may continue to obtain and process performance data and historical data associated with the secured payment instrument in real-time and as transactions involving the secured payment instrument occur in order to automatically identify any opportunities for an increase in the credit limit associated with the secured payment instrument.

If the graduation system determines that the credit limit associated with the secured payment instrument may be increased based on the identified changes in performance related to usage of the secured payment instrument, the graduation system may, at step 808, automatically increase the credit limit associated with the secured payment instrument based on these identified changes. For example, the graduation system may increase the credit limit as a result of the user making on-time payments over a period of time, making improvements in their credit performance over a period of time, staying within a pre-defined budget, and the like. The graduation system may automatically update the user's account associated with the secured payment instrument to reflect this increase in the credit limit associated with the secured payment instrument. As noted above, the increase to the credit limit associated with the secured payment instrument may be performed without requiring an additional security deposit from the user for the secured payment instrument.

At step 810, the graduation system may determine whether the ratio between the new credit limit and the security deposit amount is greater than a pre-defined threshold. As noted above, the threshold value for the ratio may be pre-defined by the payment instrument service and uniform amongst all users. Alternatively, the threshold value may be defined per user based on various criteria (e.g., credit scores, changes in credit scores, spending habits, total amount of credit allocated, total amount of credit available, payment performance, demographic information, payment instruments issued, payment instruments in default, etc.). The various criteria may also be defined according to the user metrics defined for the user and that are used to determine whether to adjust the credit limit and/or security deposit associated with the secured payment instrument.

If the graduation system determines that the ratio between the new credit limit and the security deposit is not greater than the pre-defined threshold, the graduation system, at step 812, may indicate the new credit limit to the user. Similar to the presentation of a new security deposit amount associated with the secured payment instrument when the security deposit is reduced by the graduation system, the graduation system may indicate the new credit limit through an interface (e.g., GUI) provided by the payment instrument service. Once the credit limit has been increased according to the performance data associated with the user, the graduation system may continue to process performance data and historical data associated with the secured payment instrument, thereby restarting the process 800.

If the graduation system determines that the ratio between the new credit limit and the security deposit is greater than the pre-defined threshold, the graduation system, at step 814, may automatically graduate the secured payment instrument to an unsecured payment instrument. As noted above, the graduation system may transmit a notification to the user to indicate that the secured payment instrument is being graduated to an unsecured payment instrument. Further, the graduation system may provide the user with the unsecured payment instrument while automatically cancelling the account associated with the secured payment instrument and generating a new account that is to be associated with the unsecured payment instrument. In some instances, graduation of the secured payment instrument to an unsecured payment instrument may be contingent on the user's approval to such a graduation, as described above.

In addition to automatically graduating the secured payment instrument to an unsecured payment instrument, the graduation system, at step 816, may disburse the security deposit previously used to securitize the secured payment instrument. For instance, the graduation system may retrieve the security deposit associated with the secured payment instrument for disbursement to the user. In some instances, the graduation system may provide the user with one or more options for disbursement of the remaining security deposit (e.g., direct deposit to a financial account, pay down of an existing balance associated with the account, donation to charity, etc.). These options may be presented to the user, whereby the user may select one or more disbursement options for disbursement of the security deposit associated with the secured payment instrument. Based on the user's selection, the graduation system may disburse the security deposit accordingly. In some instances, the security deposit may be disbursed to the user automatically based on one or more options previously defined by the user or otherwise defined by the payment instrument service by default.

FIG. 9 illustrates a computing system architecture 900, including various components in electrical communication with each other, in accordance with some embodiments. The example computing system architecture 900 illustrated in FIG. 9 includes a computing device 902, which has various components in electrical communication with each other using a connection 906, such as a bus, in accordance with some implementations. The example computing system architecture 900 includes a processing unit 904 that is in electrical communication with various system components, using the connection 906, and including the system memory 914. In some embodiments, the system memory 914 includes read-only memory (ROM), random-access memory (RAM), and other such memory technologies including, but not limited to, those described herein. In some embodiments, the example computing system architecture 900 includes a cache 908 of high-speed memory connected directly with, in close proximity to, or integrated as part of the processor 904. The system architecture 900 can copy data from the memory 914 and/or the storage device 910 to the cache 908 for quick access by the processor 904. In this way, the cache 908 can provide a performance boost that decreases or eliminates processor delays in the processor 904 due to waiting for data. Using modules, methods and services such as those described herein, the processor 904 can be configured to perform various actions. In some embodiments, the cache 908 may include multiple types of cache including, for example, level one (L1) and level two (L2) cache. The memory 914 may be referred to herein as system memory or computer system memory. The memory 914 may include, at various times, elements of an operating system, one or more applications, data associated with the operating system or the one or more applications, or other such data associated with the computing device 902.

Other system memory 914 can be available for use as well. The memory 914 can include multiple different types of memory with different performance characteristics. The processor 904 can include any general purpose processor and one or more hardware or software services, such as service 912 stored in storage device 910, configured to control the processor 904 as well as a special-purpose processor where software instructions are incorporated into the actual processor design. The processor 904 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 904 can be a microprocessor, a microcontroller, a digital signal processor (“DSP”), or a combination of these and/or other types of processors. In some embodiments, the processor 904 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 900, an input device 916 can represent any number of input mechanisms, such as a microphone for speech, a touch-sensitive screen for gesture or graphical input, keyboard, mouse, motion input, pen, and other such input devices. An output device 918 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 900. In some embodiments, the input device 916 and/or the output device 918 can be coupled to the computing device 902 using a remote connection device such as, for example, a communication interface such as the network interface 920 described herein. In such embodiments, the communication interface can govern and manage the input and output received from the attached input device 916 and/or output device 918. As may be contemplated, there is no restriction on operating on any particular hardware arrangement and accordingly the basic features here may easily be substituted for other hardware, software, or firmware arrangements as they are developed.

In some embodiments, the storage device 910 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 910 can include hardware and/or software services such as service 912 that can control or configure the processor 904 to perform one or more functions including, but not limited to, the methods, processes, functions, systems, and services described herein in various embodiments. In some embodiments, the hardware or software services can be implemented as modules. As illustrated in example computing system architecture 900, the storage device 910 can be connected to other parts of the computing device 902 using the system connection 906. In an embodiment, a hardware service or hardware module such as service 912, that performs a function can include a software component stored in a non-transitory computer-readable medium that, in connection with the necessary hardware components, such as the processor 904, connection 906, cache 908, storage device 910, memory 914, input device 916, output device 918, and so forth, can carry out the functions such as those described herein.

The disclosed payment instrument service, the systems of the payment instrument service, and the systems and methods for dynamically, and in real-time, adjusting a credit limit associated with a secured payment instrument can be performed using a computing system such as the example computing system illustrated in FIG. 9, using one or more components of the example computing system architecture 900. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, adjusting a credit limit associated with a secured payment instrument described herein by, for example, executing code using a processor such as processor 904 wherein the code is stored in memory such as memory 914 as described herein. One or more of a user device, a provider server or system, a database system, or other such devices, services, or systems may include some or all of the components of the computing system such as the example computing system illustrated in FIG. 9, using one or more components of the example computing system architecture 900 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 928. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 904 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 914 can be coupled to the processor 904 by, for example, a connector such as connector 906, or a bus. As used herein, a connector or bus such as connector 906 is a communications system that transfers data between components within the computing device 902 and may, in some embodiments, be used to transfer data between computing devices. The connector 906 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 914 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 914 can also include magnetic or optical data storage media including read-only (e.g., CD ROM and DVD ROM) or otherwise (e.g., CD or DVD). The memory can be local, remote, or distributed.

As described herein, the connector 906 (or bus) can also couple the processor 904 to the storage device 910, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 910. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 906 can also couple the processor 904 to a network interface device such as the network interface 920. The interface can include one or more of a modem or other such network interfaces including, but not limited to those described herein. It will be appreciated that the network interface 920 may be considered to be part of the computing device 902 or may be separate from the computing device 902. The network interface 920 can include one or more of an analog modem, Integrated Services Digital Network (ISDN) modem, cable modem, token ring interface, satellite transmission interface, or other interfaces for coupling a computer system to other computer systems. In some embodiments, the network interface 920 can include one or more input and/or output (I/O) devices. The I/O devices can include, by way of example but not limitation, input devices such as input device 916 and/or output devices such as output device 918. For example, the network interface 920 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 902 can be connected to one or more additional computing devices such as computing device 924 via a network 922 using a connection such as the network interface 920. In such embodiments, the computing device 924 may execute one or more services 926 to perform one or more functions under the control of, or on behalf of, programs and/or services operating on computing device 902. In some embodiments, a computing device such as computing device 924 may include one or more of the types of components as described in connection with computing device 902 including, but not limited to, a processor such as processor 904, a connection such as connection 906, a cache such as cache 908, a storage device such as storage device 910, memory such as memory 914, an input device such as input device 916, and an output device such as output device 918. In such embodiments, the computing device 924 can carry out the functions such as those described herein in connection with computing device 902. In some embodiments, the computing device 902 can be connected to a plurality of computing devices such as computing device 924, each of which may also be connected to a plurality of computing devices such as computing device 924. Such an embodiment may be referred to herein as a distributed computing environment.

The network 922 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 922 can be wired connections, wireless connections, or combinations thereof. Communications via the network 922 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 922, within the computing device 902, within the computing device 924, or within the computing resources provider 928 can include information, which also may be referred to herein as content. The information may include text, graphics, audio, video, haptics, and/or any other information that can be provided to a user of the computing device such as the computing device 902. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 902 and presented to a user of the computing device 902 using forms that are perceptible via sight, sound, smell, taste, touch, or other such mechanisms. In some embodiments, communications over the network 922 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 902 and/or the computing device 924 can be connected to a computing resources provider 928 via the network 922 using a network interface such as those described herein (e.g. network interface 920). In such embodiments, one or more systems (e.g., service 930 and service 932) hosted within the computing resources provider 928 (also referred to herein as within “a computing resources provider environment”) may execute one or more services to perform one or more functions under the control of, or on behalf of, programs and/or services operating on computing device 902 and/or computing device 924. Systems such as service 930 and service 932 may include one or more computing devices such as those described herein to execute computer code to perform the one or more functions under the control of, or on behalf of, programs and/or services operating on computing device 902 and/or computing device 924.

For example, the computing resources provider 928 may provide a service, operating on service 930 to store data for the computing device 902 when, for example, the amount of data that the computing device 902 exceeds the capacity of storage device 910. In another example, the computing resources provider 928 may provide a service to first instantiate a virtual machine (VM) on service 932, use that VM to access the data stored on service 932, perform one or more operations on that data, and provide a result of those one or more operations to the computing device 902. Such operations (e.g., data storage and VM instantiation) may be referred to herein as operating “in the cloud,” “within a cloud computing environment,” or “within a hosted virtual machine environment,” and the computing resources provider 928 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 928 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 930 and service 932 may implement versions of various services (e.g., the service 912 or the service 926) on behalf of, or under the control of, computing device 902 and/or computing device 924. Such implemented versions of various services may involve one or more virtualization techniques so that, for example, it may appear to a user of computing device 902 that the service 912 is executing on the computing device 902 when the service is executing on, for example, service 930. As may also be contemplated, the various services operating within the computing resources provider 928 environment may be distributed among various systems within the environment as well as partially distributed onto computing device 924 and/or computing device 902.

In an embodiment, the computing device 902 can be connected to one or more additional computing devices and/or services such as merchant computing device 936 and/or a point-of-sale service 934 via the network 922 and using a connection such as the network interface 920. In an embodiment, the point-of-sale service 934 is separate from the merchant computing device 936. In an embodiment, the point-of-sale service 934 is executing on the merchant computing device 936. In an embodiment, the point-of-sale service 934 is executing as one or more services (e.g., the service 930 and/or the service 932) operating within the environment of the computing resources provider. As used herein, a point-of-sale service 934 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 936 to interact with the point-of-sale service 934. In an embodiment, the merchant computing device 936 is a dedicated point-of-service (POS) terminal. In an embodiment, the merchant computing device 936 is a cash register system. In an embodiment, the merchant computing device 936 is an application or web service operating on a computing device such as the computing device 902 described herein. In such an embodiment, the application or web service may be provided by a financial services system (e.g., a bank, a transaction processing system, an inventory management system, or some other such financial services system). In an embodiment, the merchant computing device 936 includes an auxiliary device or system to execute tasks associated with the point-of-sale service 934 (e.g., a payment instrument processing device attached to a smart phone or tablet). In an embodiment, the merchant computing device 936 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 936 is a virtual device (e.g., a virtual kiosk) such as the virtual devices described herein. Although not illustrated here, in an embodiment, the merchant computing device 936 may be one of a plurality of devices that may be interconnected using a network such as the network 922.

In an embodiment, the computing device 902 can be connected to one or more additional computing devices and/or services such as a payment instrument service 938 via the network 922 and using a connection such as the network interface 920. In an embodiment, the payment instrument service 938 connects directly with the point of sale service 934. In an embodiment, elements of the payment instrument service 938 are executing on the merchant computing device 936. In an embodiment, the payment instrument service 938 is executing as one or more services (e.g., the service 930 and/or the service 932) operating within the environment of the computing resources provider. As used herein, a payment instrument service 938 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 938 are running as an application or web service operating on a computing device such as the computing device 902 described herein. In such an embodiment, the application or web service of the payment instrument service 938 may be provided by a financial services system (e.g., a bank, a transaction processing system, an inventory management system, or some other such financial services system). In an embodiment, elements of the payment instrument service 938 are running on an auxiliary device or system configured to execute tasks associated with the payment instrument service 938 (e.g., uses a payment instrument processing device attached to a smart phone or tablet). In an embodiment, elements of the payment instrument service 938 are running on virtual device such as those described herein. Although not illustrated here, in an embodiment, the payment instrument service 938 may be running on one or more of a plurality of devices that may be interconnected using a network such as the network 922.

In an embodiment, the computing device 902 can be connected to one or more additional computing devices and/or services such as an authentication service 940 via the network 922 and using a connection such as the network interface 920. In an embodiment, the authentication service 940 is an element of the payment instrument service 938. In an embodiment, the authentication service 940 is separate from the payment instrument service 938. In an embodiment, the authentication service 940 connects directly with the point of sale service 934. In an embodiment, elements of the authentication service 940 are executing on the merchant computing device 936. In an embodiment, the authentication service 940 is executing as one or more services (e.g., the service 930 and/or the service 932) operating within the environment of the computing resources provider. As used herein, an authentication service 940 is a service used by one or more merchants to authenticate transactions associated with payment instruments. An authentication service may be a third-party service that provides secure and verified authorization of the transactions.

In an embodiment, elements of the authentication service 940 are running as an application or web service operating on a computing device such as the computing device 902 described herein. In such an embodiment, the application or web service of the authentication service 940 may be provided by a financial services system (e.g., a bank, a transaction processing system, an inventory management system, or some other such financial services system). In an embodiment, elements of the authentication service 940 are running on an auxiliary device or system configured to execute tasks associated with the authentication service 940 (e.g., provides authentication using payment instrument processing device attached to a smart phone or tablet). In an embodiment, elements of the authentication service 940 are running on virtual device such as those described herein. Although not illustrated here, in an embodiment, the authentication service 940 may be running on one or more of a plurality of devices that may be interconnected using a network such as the network 922.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
automatically monitoring transactions associated with a secured payment instrument, wherein the secured payment instrument is secured by a security deposit, and wherein the secured payment instrument is associated with a user;
obtaining a credit evaluation corresponding to the user;
training a machine learning algorithm to identify an adjustment to the security deposit and a credit limit associated with the secured payment instrument, wherein the machine learning algorithm is trained using the transactions, the credit evaluation, historical data, and issued secured payment instruments;
updating an account associated with the secured payment instrument, wherein the account is updated according to the adjustment;
obtaining in real-time new transactions associated with the secured payment instrument and new credit evaluations corresponding to the user; and
updating the machine learning algorithm as the new transactions and the new credit evaluations are received, wherein when the machine learning algorithm is updated, new adjustments are identified.

2. The computer-implemented method of claim 1, wherein the adjustment includes automatically reducing the security deposit associated with the secured payment instrument.

3. The computer-implemented method of claim 1, wherein the adjustment includes increasing the credit limit associated with the secured payment instrument.

4. The computer-implemented method of claim 1, further comprising:
determining that the security deposit is no longer remaining as a result of the adjustment; and
automatically graduating the secured payment instrument to an unsecured payment instrument.

5. The computer-implemented method of claim 1, further comprising:
determining that a ratio between the credit limit and the security deposit is greater than a threshold amount as a result of the adjustment; and
automatically graduating the secured payment instrument to an unsecured payment instrument.

6. The computer-implemented method of claim 1, further comprising:
determining a set of user metrics for determining adjustments to the security deposit and the credit limit, wherein the set of user metrics are determined based on an initial credit evaluation corresponding to the user; and
updating the historical data according to changes in a performance associated with usage of the secured payment instrument over time, wherein the changes are determined according to the set of user metrics.

7. The computer-implemented method of claim 1, further comprising:
automatically disbursing the security deposit as a result of the adjustment.

8. A system, comprising:
one or more processors; and
memory storing thereon instructions that, as a result of being executed by the one or more processors, cause the system to:
automatically monitor transactions associated with a secured payment instrument, wherein the secured payment instrument is secured by a security deposit, and wherein the secured payment instrument is associated with a user;
obtain a credit evaluation corresponding to the user;
train a machine learning algorithm to identify an adjustment to the security deposit and a credit limit associated with the secured payment instrument, wherein the machine learning algorithm is trained using the transactions, the credit evaluation, historical data, and issued secured payment instruments;
update an account associated with the secured payment instrument, wherein the account is updated according to the adjustment;
obtain in real-time new transactions associated with the secured payment instrument and new credit evaluations corresponding to the user; and
update the machine learning algorithm as the new transactions and the new credit evaluations are received, wherein when the machine learning algorithm is updated, new adjustments are identified.

9. The system of claim 8, wherein the adjustment includes automatically reducing the security deposit associated with the secured payment instrument.

10. The system of claim 8, wherein the adjustment includes increasing the credit limit associated with the secured payment instrument.

11. The system of claim 8, wherein the instructions further cause the system to:
determine that the security deposit is no longer remaining as a result of the adjustment; and
automatically graduate the secured payment instrument to an unsecured payment instrument.

12. The system of claim 8, wherein the instructions further cause the system to:
determine that a ratio between the credit limit and the security deposit is greater than a threshold amount as a result of the adjustment; and
automatically graduate the secured payment instrument to an unsecured payment instrument.

13. The system of claim 8, wherein the instructions further cause the system to:
determine a set of user metrics for determining adjustments to the security deposit and the credit limit, wherein the set of user metrics are determined based on an initial credit evaluation corresponding to the user; and
update the historical data according to changes in a performance associated with usage of the secured payment instrument over time, wherein the changes are determined according to the set of user metrics.

14. The system of claim 8, wherein the instructions further cause the system to:
automatically disburse the security deposit as a result of the adjustment.

15. A non-transitory, computer-readable storage medium storing thereon executable instructions that, as a result of being executed by one or more processors of a computer system, cause the computer system to:
automatically monitor transactions associated with a secured payment instrument, wherein the secured payment instrument is secured by a security deposit, and wherein the secured payment instrument is associated with a user;
obtain a credit evaluation corresponding to the user;
train a machine learning algorithm to identify an adjustment to the security deposit and a credit limit associated with the secured payment instrument, wherein the machine learning algorithm is trained using the transactions, the credit evaluation, historical data, and issued secured payment instruments;
update an account associated with the secured payment instrument, wherein the account is updated according to the adjustment;
obtain in real-time new transactions associated with the secured payment instrument and new credit evaluations corresponding to the user; and
update the machine learning algorithm as the new transactions and the new credit evaluations are received, wherein when the machine learning algorithm is updated, new adjustments are identified.

16. The non-transitory, computer-readable storage medium of claim 15, wherein the adjustment includes automatically reducing the security deposit associated with the secured payment instrument.

17. The non-transitory, computer-readable storage medium of claim 15, wherein the adjustment includes increasing the credit limit associated with the secured payment instrument.

18. The non-transitory, computer-readable storage medium of claim 15, wherein the executable instructions further cause the computer system to:
determine that the security deposit is no longer remaining as a result of the adjustment; and
automatically graduate the secured payment instrument to an unsecured payment instrument.

19. The non-transitory, computer-readable storage medium of claim 15, wherein the executable instructions further cause the computer system to:
determine that a ratio between the credit limit and the security deposit is greater than a threshold amount as a result of the adjustment; and
automatically graduate the secured payment instrument to an unsecured payment instrument.

20. The non-transitory, computer-readable storage medium of claim 15, wherein the executable instructions further cause the computer system to:
determine a set of user metrics for determining adjustments to the security deposit and the credit limit, wherein the set of user metrics are determined based on an initial credit evaluation corresponding to the user; and
update the historical data according to changes in a performance associated with usage of the secured payment instrument over time, wherein the changes are determined according to the set of user metrics.

21. The non-transitory, computer-readable storage medium of claim 15, wherein the executable instructions further cause the computer system to:
automatically disburse the security deposit as a result of the adjustment.
